(19) United States
(12) Patent Application Publication
(10) Pub. No.: US 2025/0308009 A1
(43) Pub. Date: Oct. 2, 2025

(54) IMAGE-BASED CHEMICAL ANALYSIS

(71) Applicant: The Florida State University Research Foundation, Inc., Tallahassee, FL (US)

(72) Inventors: Oliver Steinbock, Tallahassee, FL (US); Bruno C. Batista, Tallahassee, FL (US)

(21) Appl. No.: 19/075,295

(22) Filed: Mar. 10, 2025

Related U.S. Application Data
(60) Provisional application No. 63/562,973, filed on Mar. 8, 2024.

(51) Int. Cl. G06T 7/00; G06T 7/62; G06V 10/44; G06V 10/75; G06V 10/77; G06V 10/82

(52) U.S. Cl. CPC G06T 7/0002; G06T 7/62; G06V 10/44; G06V 10/75; G06V 10/77; G06T 2207/20036; G06T 2207/20084; G06V 10/82

(57) ABSTRACT

An example method of analyzing a composition includes evaporating a solution or dispersion, acquiring an image of the resulting deposit, extracting morphological features from the image of the deposit, and determining a composition and solute concentration of the solution or dispersion based on the morphological features extracted from the image.

### CROSS-REFERENCE TO RELATED APPLICATIONS

This application claims the benefit of U.S. provisional patent application No. 63/562,973, filed on Mar. 8, 2024, and titled “CHEMICAL COMPOSITION FROM PHOTOS: DRIED SOLUTION DROPS REVEAL AN UNEXPECTED MORPHOGENETIC TREE,” the disclosure of which is expressly incorporated herein by reference in its entirety.

### ACKNOWLEDGEMENT OF GOVERNMENT SUPPORT

This invention was made with government support under grant no. 80NSSC23M0050 awarded by the National Aeronautics and Space Administration. The government has certain rights in the invention.

### BACKGROUND

Chemical analysis can include evaluating the properties of an unknown sample. Chemical analysis can be used in fields including food science, forensics, waste treatment, and environmental engineering, as some examples. Different chemical samples can have distinct physical structures. Improvements to chemical analysis can improve scientific techniques that require the identification of chemicals.

### SUMMARY

In some aspects, implementations of the present disclosure include a computer-implemented method of analyzing a chemical composition and concentrations including: evaporating a fluid, wherein the fluid is a dispersion or a solution including a solute or dispersed particles, to create a dried deposit; acquiring an image of the dried deposit; extracting a plurality of morphological features from the image of the dried deposit; and determining a composition of the solute or dispersed particles based on the plurality of morphological features.

In some aspects, implementations of the present disclosure include a computer-implemented method, wherein determining the composition of the solute or dispersed particles includes a direct vector-based comparison between the image of the dried deposit and a plurality of reference vectors extracted from a plurality of reference images.

In some aspects, implementations of the present disclosure include a computer-implemented method, wherein determining the composition of the solute or dispersed particles includes inputting the morphological features or images into a trained machine learning model includes at least one of, a decision tree, random forest model, or neural network.

In some aspects, implementations of the present disclosure include a computer-implemented method, wherein determining the composition of includes computing a distance measure in an underlying space of metrics.

In some aspects, implementations of the present disclosure include a computer-implemented method, wherein the plurality of morphological features includes a measure of holes.

In some aspects, implementations of the present disclosure include a computer-implemented method, wherein the plurality of morphological features includes a measure of total area.

In some aspects, implementations of the present disclosure include a computer-implemented method, wherein the plurality of morphological features includes a measure of connected areas.

In some aspects, implementations of the present disclosure include a computer-implemented method, further including outputting a measure of water or other liquid quality based on the composition of the solute or dispersed particles.

In some aspects, implementations of the present disclosure include a system for chemical analysis, including: an imaging device; a controller operably coupled to the imaging device, the controller including a processor and a memory operably coupled to the processor, the memory storing instructions which, when executed by the processor, cause the controller to: receive an image of a dried deposit from the imaging device; extract a plurality of morphological features from the image of the dried deposit; and determine a composition of the dried deposit based on the plurality of morphological features.

In some aspects, implementations of the present disclosure include a system, further including a non-porous substrate configured to dry a solution to create the dried deposit.

In some aspects, implementations of the present disclosure include a system, wherein the imaging device includes a mobile computing device.

In some aspects, implementations of the present disclosure include a system, wherein determining the composition of the dried deposit includes inputting the morphological features into a trained machine learning model or computing a distance measure in an underlying space of metrics.

In some aspects, implementations of the present disclosure include a system, wherein the trained machine learning model includes at least one of a decision tree, random forest model, or neural network.

In some aspects, implementations of the present disclosure include a system, wherein the plurality of morphological features include a measure of holes.

In some aspects, implementations of the present disclosure include a system wherein the plurality of morphological features include a measure of total area.

In some aspects, implementations of the present disclosure include a method, wherein the plurality of morphological features include a measure of connected areas.

In some aspects, implementations of the present disclosure include a method, further including outputting a measure of water quality based on the composition of the solute or dispersed particles.

In some aspects, implementations of the present disclosure include a method of training a random-forest classifier including: receiving a plurality of high-resolution images, wherein the plurality of high-resolution images represent a plurality of dried deposits corresponding to a plurality of sample types; extracting a plurality of morphological features from the high-resolution images; creating a multidimensional vector for each sample type based on the morphological features for each sample type; training the random-forest classifier to determine a composition of an unknown sample based on an image of a dried deposit of the unknown sample.

In some aspects, implementations of the present disclosure include a method, wherein the plurality of morphological features include at least one of: salt free holes, connected salt areas, and total salt area.

In some aspects, implementations of the present disclosure include a method, wherein the high-resolution images include binary images.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE FIGURES

The components in the drawings are not necessarily to scale relative to each other. Like reference numerals designate corresponding parts throughout the several views.

FIG. 1 illustrates an example system for chemical analysis, according to implementations of the present disclosure.

FIG. 2A illustrates an example method for chemical analysis, according to implementations of the present disclosure.

FIG. 2B illustrates an example method of training a machine learning model to perform chemical analysis, according to implementations of the present disclosure.

FIG. 3 illustrates an example computing device.

FIG. 4 illustrates example deposit patterns of 10 μL drops of different aqueous salt solutions acquired in a study of an example implementation of the present disclosure.

FIG. 5 illustrates image analysis and a family tree of salt deposits acquired in a study of an example implementation of the present disclosure.

FIG. 6 illustrates identification of composition from deposit patterns, according to an example implementation of the present disclosure.

FIG. 7 illustrates deposit patterns of binary salt mixtures, according to a study of an example implementation of the present disclosure.

FIG. 8 illustrates time sequences showing the drying process for 12 salts according, to a study of an example implementation of the present disclosure.

FIG. 9 illustrates optical micrographs of the deposit patterns of 12 different salts, according to a study of an example implementation of the present disclosure.

FIG. 10 illustrates side views of dried deposits, according to a study of an example implementation of the present disclosure.

FIG. 11 illustrates examples for the deposit patterns created by 10 μL drops of aqueous solutions of example salts, according to a study of an example implementation of the present disclosure.

FIG. 12A illustrates image erosion behavior for the patterns illustrated for four salts, according to a study of an example implementation of the present disclosure.

FIG. 12B illustrates the progressive thinning and reduction of image features by erosion, according to a study of an example implementation of the present disclosure.

FIG. 13 illustrates experimental results including an analysis of 500 images, according to a study of an example implementation of the present disclosure.

FIG. 14 illustrates the correlation coefficients between the different Z-scored metrics as measured from the 6000 images of the 12 key salts, according to a study of an example implementation of the present disclosure.

FIG. 15 illustrates an analysis of 6000 deposit patterns, according to a study of an example implementation of the present disclosure.

FIG. 16 illustrates an identification of “bifurcated” salts, according to a study of an example implementation of the present disclosure.

FIG. 17 illustrates an overview showing representative examples of salts, according to a study of an example implementation of the present disclosure.

FIG. 18 illustrates XRD patterns of the deposits formed by the three studied salt mixtures, according to a study of an example implementation of the present disclosure.

FIG. 19 illustrates SEM images and EDS maps of deposit subsections formed from evaporating drops of KNO₃/NaCl, NH₄Cl/NaCl, and KNO₃/NH₄Cl solution mixtures, according to a study of an example implementation of the present disclosure.

FIG. 20 illustrates an effect of the initial drop volume on the different metrics used to characterize the deposit patterns, according to a study of an example implementation of the present disclosure.

FIG. 21 illustrates a machine learning analysis of the 42 salts based on 21 samples each

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event, or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for analysis of salts, it will become evident to those skilled in the art that the implementations are not limited thereto, but are applicable for identification and/or analysis of other chemicals.

Implementations of the present disclosure include systems for chemical analysis that can overcome limitations of existing chemical analysis systems. Conventional chemical analysis can rely on complex assays or spectrographic techniques, which can require expensive equipment, and multistep processes including different reagents. Additionally, colorimetric tests (e.g., titrations) can be ambiguous. This can prevent chemical analysis from being performed cheaply, quickly, and/or on-site (e.g., in mobile contexts). Implementations of the present disclosure address these and other problems with conventional chemical analysis techniques by using images to perform chemical analysis. In particular example systems and methods described herein use computing devices (e.g., mobile computing devices like smartphones and laptops) to analyze images captured from evaporated samples. The image analysis techniques described herein can extract image features and determine the composition of a sample from the evaporation pattern of the sample (e.g., by using trained machine learning models). By analyzing evaporation patterns, samples with very low mass can be identified. Additionally, the systems and methods described herein can include receiving an estimate of sample volume to estimate concentrations of a solute or dispersed particles in a sample.

Implementations of the present disclosure further include methods for training machine learning models to perform chemical analysis based on images of evaporated chemical samples. A study described herein includes an example implementation of the present disclosure configured to determine the composition of a salt or solute or dispersed particles based on an evaporation pattern.

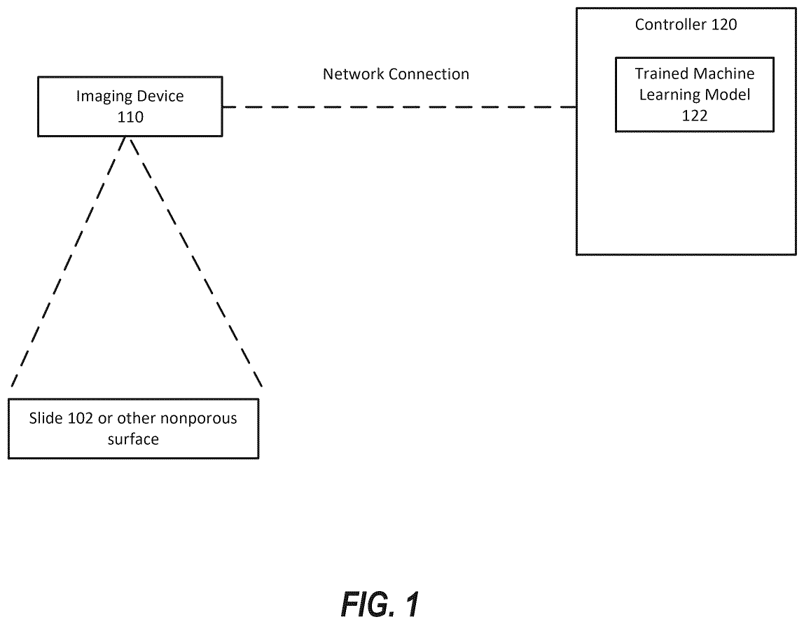

With reference to FIG. 1, an example system is shown according to implementations of the present disclosure. The system can include a slide 102 for drying a solution including a chemical sample. When dried, the remaining sample forms a “stain” or “dried deposit” on the slide 102, for example if the chemical is a salt solution, then the dried deposit can be a salt stain. Alternatively or additionally, the system can be configured to image dried deposits on any surface (e.g., nonporous surfaces).

The system can further include an imaging device 110 configured to image the slide. The imaging device 110 can be any type of camera or other sensor. In some implementations, the imaging device can be a digital camera (e.g., a camera that is part of a smartphone or other mobile device).

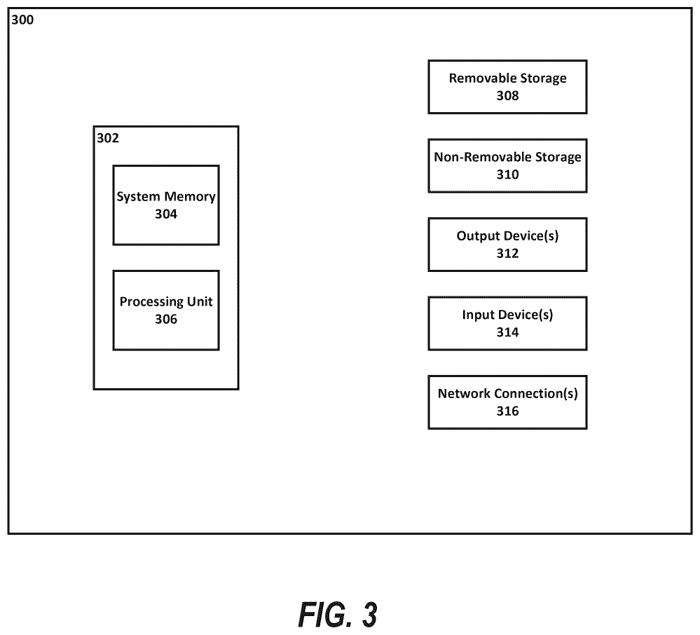

The imaging device 110 can be in operable communication with a controller 120. The controller 120 can include any or all of the features of the computing device 300 shown in FIG. 3, for example a processor and a memory configured to store computer-executable instructions for the processor. The controller 120 can be networked (e.g., by a wireless or wired connection) to the imaging device 110. Alternatively or additionally, both the imaging device 110 and the controller 120 can be part of the same mobile device (e.g., the controller 120 can be a processor of a smartphone or other mobile device and the imaging device 110 can also be part of the smartphone or other mobile device). One or more images acquired by the imaging device 110 can be transmitted to the controller 120 for the controller 120 to analyze the image and determine or estimate a composition of the chemical sample on the slide.

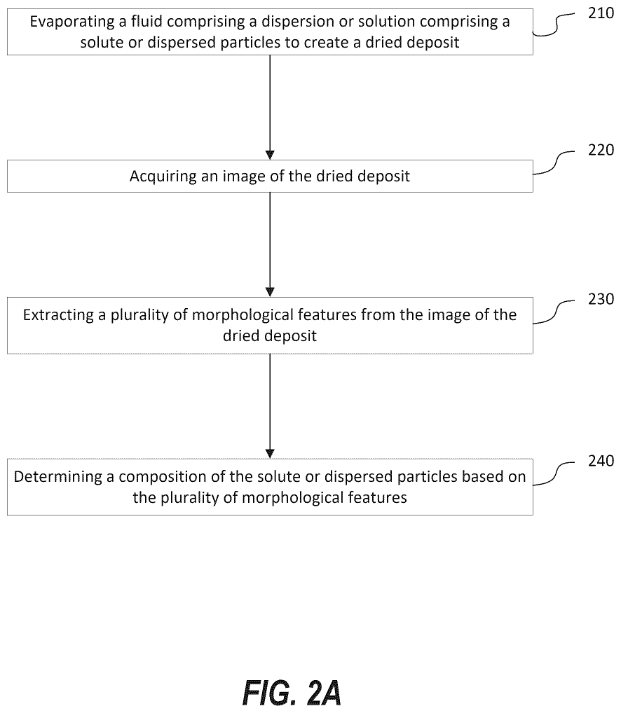

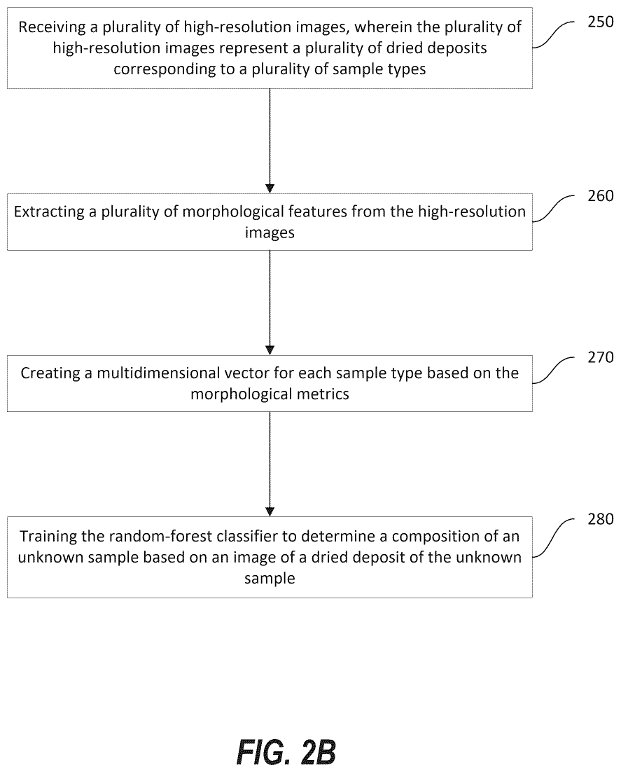

Optionally, the controller 120 can store a trained machine learning model 122 configured to detect the type chemical on the slide. The trained machine learning model 122 can optionally be a machine learning model trained according to the methods described herein, including the methods shown in FIG. 2B.

The system shown in FIG. 1 can be configured to perform the methods described herein. For example, the controller can include computer-executable instructions to perform the methods of analyzing chemical compositions illustrated in FIGS. 2A and 2B. FIG. 2A illustrates an example method of chemical analysis. The methods of chemical analysis can include analyzing chemical samples (e.g., liquids including solutions or dispersions) through evaporation.

At step 210, the method includes evaporating a solution or dispersion (e.g., a solution comprising a salt) to create a dried deposit.

At step 220, the method includes acquiring an image of the dried deposit.

At step 230, the method includes extracting a plurality of morphological features from the image of the dried deposit. Non-limiting examples of morphological features include holes, total area, and connected areas. Additional examples of morphological features are described in the Example, herein. Extracting morphological features can further include image processing steps. For example, any or all of the following image processing steps can be performed: the image can be converted into a binary image, the image can be noise reduced, gray scale conversion can be performed, color correction can be performed, glare reduction can be performed, and/or background removal can be performed. As yet another example, morphological image processing techniques like erosion can be applied to the image to remove boundary pixels. Erosion can be configured to perform noise reduction and/or, identify boundaries of the dried deposit in the image.

At step 240, the method includes determining a composition of the dried deposit based on the plurality of morphological features. Step 240 can optionally include estimating the likelihood that certain types of solute or dispersion are present, outputting a detection that a chemical or compound is present, and/or outputting an estimated composition of the sample.

Optionally, determining the composition of the dried deposit can be performed by a direct vector-based comparison between the image of the dried deposit and a set of reference vectors extracted from a set of reference images (e.g., images of dried deposit compositions). For example, a distance measure in the underlying space of metrics can be performed. Optionally, z-scoring can be performed. Alternatively or additionally, the method can include using a trained machine learning model (e.g. a model trained according to the methods described herein) to classify the dried deposit. The morphological features extracted at step 230 can be used as inputs to the trained machine learning model. Non-limiting examples of trained machine learning models that can be used include decision trees, random forest models, and neural networks.

In some implementations, the method can further include outputting an estimate of water quality and/or a measurement of purity/contamination (e.g., of food, beverages, etc.) based on the composition of the dried deposit determined at step 240. Additionally, the present disclosure contemplates that the estimates/measurements described herein can include health markers for biofluids, volume, concentration, environmental quality (e.g., predicting algae blooms).

FIG. 2B illustrates an example method of training a machine learning model (e.g., a random-forest classifier) for chemical analysis, according to implementations of the present disclosure. At step 250, the method includes receiving high-resolution images. The high-resolution images can include images of dried deposits for any type of chemical sample.

Optionally, the high-resolution images can be converted into binary images. Optionally, implementations of the present disclosure can further include receiving estimates of a sample volume for the fluid that the dried deposit was a solution or dispersion in.

At step 260, the method can include extracting a plurality of morphological features from the high-resolution images. The morphological features can include any image features, however non-limiting examples of features include holes, connected areas, and/or total area. Additional example morphological features are described in the table below.

| | | |
|---|---|---|
| 1 | numWhitePixels | This measure is the total count of white pixels. It specifies |
| | | the total deposit area. |
| 2 | numBlackPixels | This measure is the total count of black pixels within |
| | | regions surrounded by white pixels. Notice that this |
| | | quantity is sensitive to small gaps in the white regions that |
| | | connect the black region to the global background. If such |
| | | a gap exists, the black area is not analyzed. |
| 3 | ratio | This measure is the ratio of the pixel counts in 2 and 1. |
| 4 | numLargeBlobs | This measure is the total number of connected white areas. |
| 5 | perimeterLength | This measure is the sum of the perimeter lengths of all |
| | | connected white areas. For a given total white area, it |
| | | increases with numLargeBlobs and the eccentricity of the |
| | | individual blobs. |
| 6 | axisRatio | This measure is the eccentricity as calculated from the |
| | | best-fit ellipse for all white pixels. Values larger than one |
| | | indicate that the deposit deviates from a circular disk. |
| 7 | countLargeHoles | This measure is the number of black connected areas |
| | | (holes) larger than 1000 pixels. |
| 8 | medianLargeHoleAreas | This measure is the median value of the black connected |
| | | areas (holes) larger than 1000 pixels. |
| 9 | maxLargeHoleAreas | This measure is the maximum value of the black connected |
| | | areas (holes) larger than 1000 pixels. |
| 10 | meanDistances | This measure is the average of the distances of all white |
| | | pixels from their common centroid. |
| 11 | stdDistances | This measure is the standard deviation of the distances of |
| | | all white pixels from their common centroid. |
| 12 | modeDistances | This measure is the most frequent value among the |
| | | distances of all white pixels from their common centroid. |
| 13 | medianDistances | This measure is the median of the distances of all white |
| | | pixels from their common centroid. |
| 14 | skewnessDistances | This measure is the degree of asymmetry observed in the |
| | | distribution of the distances of all white pixels from their |
| | | common centroid. Zero implies a symmetric distribution, |
| | | whereas positive (negative) values indicate that the |
| | | distribution is skewed to the right (left). |
| 15 | erosionslope | We compute the fraction of the remaining white pixels f |
| | | after erosion with disks of radius r. The slope of f(r) for |
| | | small disk radii (0-4 pixels) defines this measure. Large |
| | | values indicate the presence of fine details in the deposit |
| | | pattern. |
| 16 | frct01 | We compute the fraction of the remaining white pixels f |
| | | after erosion with disks of radius r. The smallest disk |
| | | radius for which f(r) ≤0.1 defines this integer measure. |
| | | Large values indicate compact deposit patterns such as |
| | | featureless white disks. |
| 17 | medianEccentricity | The median eccentricity of connected regions |
| | | above the high threshold. Eccentricity measures how |
| | | elongated a shape is, with values closer to 1 indicating |
| | | more elongated shapes. |
| 18 | medianArea | The median area of connected regions above the high |
| | | threshold. This represents the typical size of the bright |
| | | precipitate regions. |
| 19 | sumEdgesLow | The ratio of the edge points detected in the low-threshold |
| | | binary image to the precipitate area. It provides a measure |
| | | of edge density, indicating how jagged or smooth the |
| | | precipitate boundary is in less intense regions. |
| 20 | sumEdgesHigh | The ratio of the edge points detected in the |
| | | high-threshold binary image to the precipitate area. This |
| | | metric focuses on the density of edges in the brighter, more |
| | | intense regions of the precipitate. |
| 21 | areaOverEdgeLow | The ratio of the total precipitate area to the number of edge |
| | | points in the low-threshold image. A higher value suggests |
| | | larger, more contiguous precipitate regions relative to their |
| | | boundary length. |
| 22 | areaOverEdgeHigh | The ratio of the total precipitate area to the number of edge |
| | | points in the high-threshold image. This metric assesses the |
| | | relationship between the area of brighter regions and their |
| | | boundary complexity. |
| 23 | stdRaw | The standard deviation of pixel intensities above the low |
| | | threshold. It quantifies the variability in intensity within |
| | | the precipitate, indicating how uniform or heterogeneous |
| | | the precipitate is. |
| 24 | areaHigh | The total number of pixels above the high threshold, |
| | | representing the area of the more intense, bright precipitate |
| | | regions. |
| 25 | stdHigh | The standard deviation of pixel intensities above the high |
| | | threshold. This measures the intensity variability within the |
| | | bright regions of the precipitate. |
| 26 | compactnessCenter | The fraction of pixels above the low threshold within a |
| | | defined central disk (radius radiCenter = 200 pixels) |
| | | around the centroid. This indicates how densely packed the |
| | | precipitate is in the core region. |
| 27 | brightnessCenter | The average brightness of pixels within the central disk |
| | | (radius radiCenter = 200 pixels) around the centroid. This |
| | | metric provides an overall measure of the intensity in the |
| | | core region. |
| 28 | blackCoreFraction | The fraction of pixels below the low threshold within the |
| | | central disk, indicating the proportion of dark areas in the |
| | | core region relative to the total core area. |
| 29 | intensityKurtosis | The kurtosis of pixel intensities above the low |
| | | threshold. Kurtosis measures the “tailedness” of the |
| | | intensity distribution, with higher values indicating more |
| | | pronounced peaks. |
| 30 | intensitySkewness | The skewness of pixel intensities above the low |
| | | threshold. Skewness measures the asymmetry of the |
| | | intensity distribution, with positive values indicating a |
| | | right-skewed distribution and negative values indicating a |
| | | left-skewed distribution. |
| 31 | intensityRatio | The ratio of average intensities between inner and outer |
| | | ring-sections of the precipitate. This metric assesses radial |
| | | intensity variation from the center outwards. |
| 32 | skeletonLength | The ratio of the length of the skeletonized |
| | | precipitate (a representation of its structure) to the |
| | | precipitate area. This indicates structural complexity and |
| | | connectivity within the precipitate. |
| 33 | skeletonBranchPoints | The ratio of skeleton branch points (junctions in the |
| | | skeleton) to the precipitate area, indicating the complexity |
| | | and branching nature of the structure. |
| 34 | skeletonEndPoints | The ratio of skeleton endpoints to the |
| | | precipitate area, providing a measure of the number of |
| | | terminal points in the skeleton. |
| 35 | fractalDim | An estimate of the fractal dimension, representing the |
| | | complexity and self-similarity of the precipitate structure. |
| | | Higher values indicate more complex, self-similar |
| | | structures. |
| 36 | log10Entropy | The log-transformed entropy of the image normalized by |
| | | the precipitate area. Entropy measures the randomness of |
| | | pixel intensities, with higher values indicating more |
| | | complex textures. |
| 37 | waveletEntropy | The entropy of wavelet coefficients normalized by the |
| | | precipitate area, representing the complexity and |
| | | variability of textures at different scales. |
| 38 | stdRays | The standard deviation of average intensities along radial |
| | | directions from the center. This measures how much the |
| | | intensity varies as you move outwards in different |
| | | directions. |
| 39 | lowRays | This metric measures the median intensity of the darkest |
| | | 10% of radial lines extending from the center of the |
| | | precipitate outward. It evaluates the average pixel intensity |
| | | along each radial line and focuses on the dimmest regions |
| | | to capture variations in brightness across different |
| | | directions. This metrie helps quantify the spread of low- |
| | | intensity areas within the precipitate, providing insights |
| | | into uneven material or light distribution. |
| 40 | stdMaxRays | The standard deviation of the largest radii found along |
| | | different angles from the center, indicating the variation in |
| | | the boundary distance from the center. |
| 41 | corrGLCM | The correlation from the Gray-Level Co-Occurrence |
| | | Matrix (GLCM), which measures the relationship between |
| | | pixel intensities and their spatial dependencies, indicating |
| | | texture consistency. |
| 42 | energyGLCM | The energy from the GLCM, which quantifies the |
| | | uniformity of textures. Higher values indicate more |
| | | homogeneous textures. |
| 43 | meanStd5 | The average local standard deviation (calculated with a |
| | | disk radius of 5 pixels) normalized by the precipitate area, |
| | | indicating small-scale textural variation. |
| 44 | meanStd25 | The average local standard deviation (calculated with a |
| | | disk radius of 25 pixels) normalized by the precipitate area, |
| | | indicating medium-scale textural variation. |
| 45 | ms25over5 | The ratio of medium-scale to small-scale local |
| | | standard deviations, providing insight into the relative |
| | | textural variation at different scales. |
| 46 | ms100over25 | The ratio of large-scale (disk radius of 100 |
| | | pixels) to medium-scale local standard deviations, further |
| | | indicating textural variation at different levels. |
| 47 | numContours | The ratio of the number of contours detected in the high- |
| | | threshold image to the precipitate area, indicating the |
| | | complexity and number of distinct regions within the |
| | | precipitate. |

At step 270, a multidimensional vector can be created for each dried deposit based on the morphological features for each dried deposit.

At step 280, the machine learning model can be trained to determine a composition of an unknown dried deposit based on an image of the unknown dried deposit. In implementations of the present disclosure where the sample volume is included as a training parameter, the machine learning model can optionally be further configured to output a an estimated concentration of a solute or dispersion in the sample.

While the examples herein are often described with reference to salts, it should be understood that the methods of chemical analysis described herein can be applied to other chemicals, including both dispersions and/or solutions. Thus, the methods of FIGS. 2A and 2B can be applied to any dried deposit formed from any solute or dispersed particles. For example, the methods of FIGS. 2A and 2B can be used to identify nonionic solutes, organic compounds, pharmaceuticals, bacteria, blood (e.g., white and/or red blood cell concentrations), beverages (e.g., types of beer, wine, soda, spirits, teas, etc.) based on dried deposits from those various substances.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Machine Learning. In addition to the machine learning features described above, the various systems and methods herein can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an ANN is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

### EXAMPLES

An example implementation of the present disclosure way studied for analysis of salt crystal structures.

Theories of crystal growth have benefitted chemistry and related sciences. [12] Crystalline materials are examples of emerging features that are challenging to predict based solely on their microscopic building blocks. [34] Research has applied this concept of self-assembly to structures of increasing complexity and size. [5, 6] Further extensions, may involve self-organization under far-from-equilibrium conditions which produce nonlinear dynamics and circumvent energy minima. [7] The resulting materials can resemble living forms and shapes, even in the case of purely inorganic building blocks as exemplified by Liesegang patterns, chemical gardens, and biomorphs. [8, 9, 10] Typical driving forces in these open systems are self-sustained, steep gradients that control reactions via diffusive fluxes and convection. Understanding and directing these transport processes is not only significant for the growth of large, well-formed crystals but also opens new avenues for the production of hierarchically ordered and spatially organized materials. For this approach to be successful, matter needs to be interpreted as distinct meso- and macroscopic patterns and pattern classes. [11]

Considering the profound effects of gradients and transport on crystallization, evaporites and related precipitates include many complex patterns. Evaporites are water-soluble mineral deposits that form during evaporation. They have attracted significant attention due to their geological and industrial importance with sequential crystallization from mixtures being a key focus since the pioneering work of van′t Hoff. [12] They have also been identified on Mars and Saturn's moon Titan where liquid methane substitutes for water. [13] Other related phenomena include salt crusts on soils and efflorescence which is the movement of salts out of rocks and building materials (e.g. limestone) followed by surface-bound precipitation. [14, 15, 16]. These examples demonstrate the relevance of evaporation-driven and transport-mediated crystallization across a broad range of systems.

An example case is the crystallization of evaporating drops on nonporous surfaces. The resulting deposits can show a wealth of patterns and dynamics. For example, drying drops of spilled coffee cause ring-shaped deposits that are common for liquids with dispersed solids. This pattern is caused by the free surface, constrained by a pinned contact line, pushing the liquid outwards to counterbalance for evaporative losses. [17, 18] Another intriguing effect is salt creep which occurs when the crystallization of certain salts (e.g. ammonium chloride, NH₄Cl) leads to a large increase in the footprint of the dried pattern compared to the initial drop. [19, 20, 21, 22, 23] Salt creep also occurs along vertical surfaces creating extended crust layers that can affect moving parts and corrosion-prone components. The processes giving rise to creep are complex but usually involve the wicking-like and capillarity-driven motion of the solution over or along small crystallites.

Drying sessile drops of solutions and suspensions can form many additional patterns ranging from single crystals to dome-shaped rims that occasionally are breached leading to micro-flooding events that in turn produce multi-ring deposit layers. [24, 25] Some of these patterns find widespread applications, such as in electrochemistry where drop-casting is used to improve electrocatalytic analyses and sensing techniques. [26] For these applications, ring formation is undesired and Marangoni flows as well as surface acoustic waves are used to create homogeneous patterns. [26] Drop deposits also provide inexpensive bioanalytical techniques [27] such as the diagnosis of dry-eye disease from fern-like patterns in dried teardrops [28]. In addition, blood drops from patients with leukemia, anemia, and other diseases are believed to produce well-differentiated patterns. [29] Another curious phenomenon is that evaporating solution drops on heated, superhydrophobic surfaces form leg-like salt structures that self-lift and eject the growing deposits. [30, 31]

The study herein surveys these patterns for a select group of highly soluble, inorganic salts. Implementations of the present disclosure include an automated analysis method, that can place a collection of 7500 images into a 16-dimensional morphospace [32]. This information then allows the reliable identification of a specific salt from its deposit pattern. Even larger image collections can yield an inexpensive yet versatile analytical method to determine (or narrow) the composition of both man-made and natural deposits and stains from photos. This approach can benefit weight-restricted space missions aiming to identify brines on Mars or ocean waters on Europa and other moons. As yet additional examples, cell-phone-based applications with impacts in fields ranging from environmental science and criminology to home and lab safety. In addition, the study reveals initial branches of a pattern-based family tree of salts, highlighting deep physicochemical similarities that extend beyond mere chemical formulas. These similarities are influenced by factors such as thermodynamics, crystal growth, and transport processes, yet their underlying connections remain unexplained.

Under nonequilibrium conditions, inorganic systems can produce a wealth of life-like shapes and patterns which, compared to well-formed crystalline materials, remain widely unexplored. A seemingly simple example is the formation of salt deposits during the evaporation of sessile droplets. These evaporites show great variations in their specific patterns including single rings, creep, small crystals, fractals, and featureless disks. The study explored the patterns of 42 different salts at otherwise constant conditions. Based on 7500 images, the study shows that distinct pattern families can be identified and that some salts (e.g. Na₂SO₄ and NH₄NO₃) are bifurcated creating two distinct motives. Family affiliations cannot be predicted a priori from composition alone but rather emerge from the complex interplay of evaporation, crystallization, thermodynamics, capillarity, and fluid flow.

Nonetheless, chemical composition can be predicted from the deposit pattern with surprisingly high accuracy even if the set of reference images is small. These findings suggest possible applications including smartphone-based analyses and lightweight tools for space missions.

### Results

The study focused on the deposit patterns of 12 different “key” salts and 30 additional reference salts, for which the study recorded a total of 7500 high-resolution images. These drops were pipetted onto horizontal glass slides and, unless noted otherwise, had an initial volume of 10 μL unless stated otherwise. It should be understood that the “key salts” are intended as non-limiting examples used in the study, and that the systems and methods described in the present disclosure can be applied to other salts and/or other chemicals.

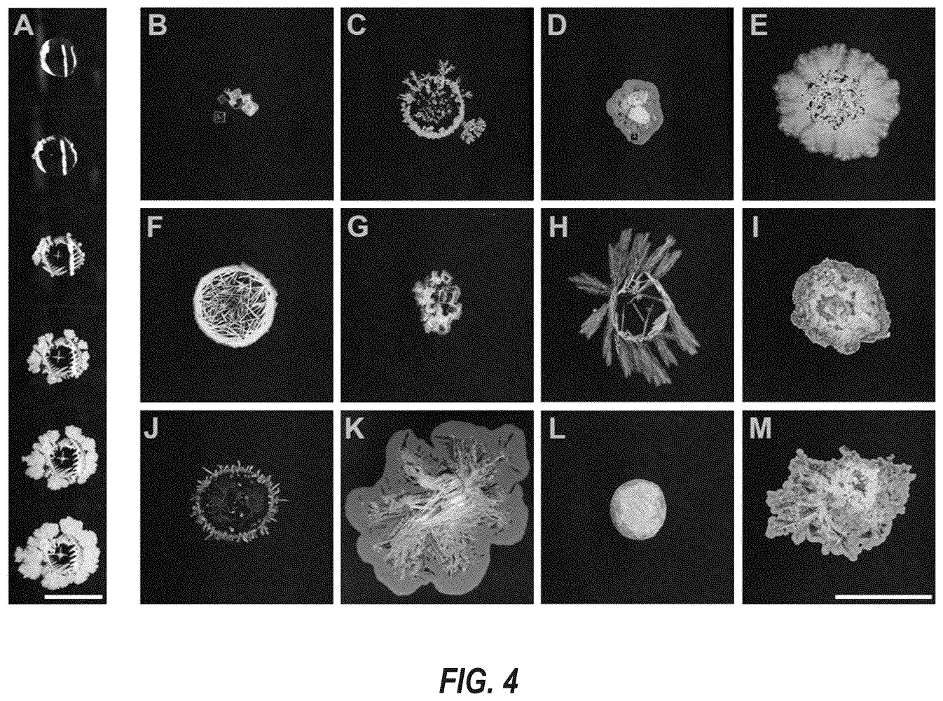

FIG. 4 illustrates deposit patterns of 10 μL drops of different aqueous salt solutions formed under ambient conditions on glass. Panel A illustrates Time sequence showing the evaporation-driven formation of NH₄Cl deposit. Time between snapshots: 190 s. The remaining panels of FIG. 4 illustrate representative images of other deposit patterns: where Panel B shows NaCl, Panel C shows Na₂SO₄, Panel D shows KCl, Panel E shows NH₄Cl, Panel F shows Na₃PO₄, Panel G shows KBr, Panel H shows KNO₃, Panel I shows RbCl, Panel J shows K₂SO₄, Panel K shows NH₄NO₃, Panel L shows NaH₂PO₄, and Panel M shows NaNO₃. Scale bars: 1 cm (Panels B-M).

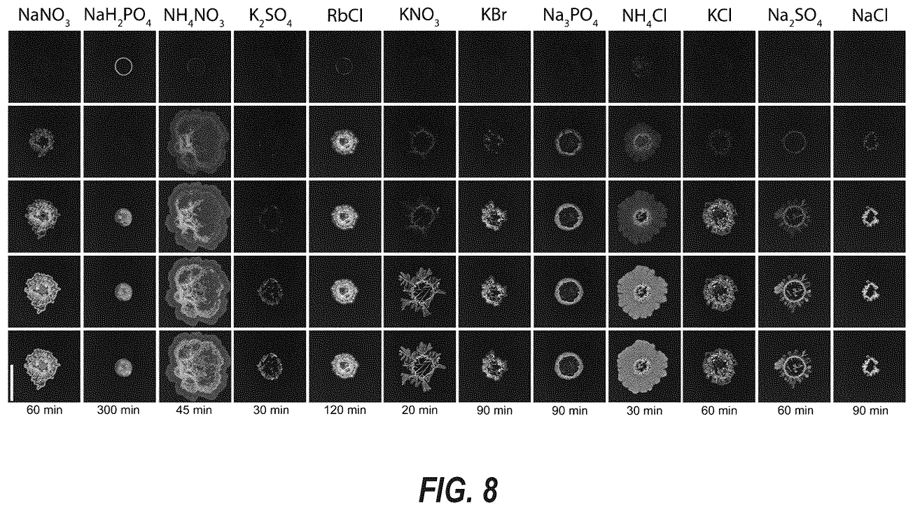

FIG. 4, Panel A shows an example of the drying process of a sessile drop of saturated NH₄Cl(aq) (additional salts in FIG. 8). The last frame in panel A is recorded after 16 min, which is slightly shorter than the evaporation time of a pure water drop of equal volume (20 min). This faster evaporation is related to the creeping behavior of NH₄Cl, which in this example increased the footprint area by 250%. The presence of a saturated salt can also increase the evaporation time, with LiCl being an extreme case for which no volume loss occurs unless the relative humidity is lowered to about 10-20%. [33] Some other saturated salt solutions, such as NH₄NO₃, have greatly varying evaporation times that correlate with the nucleation of crystals in the drop.

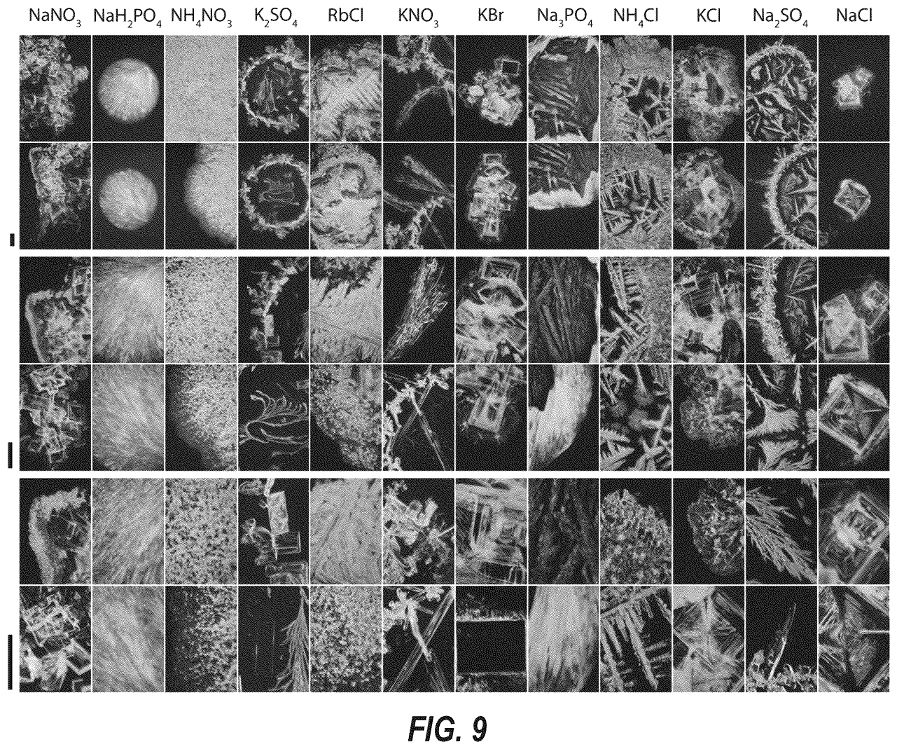

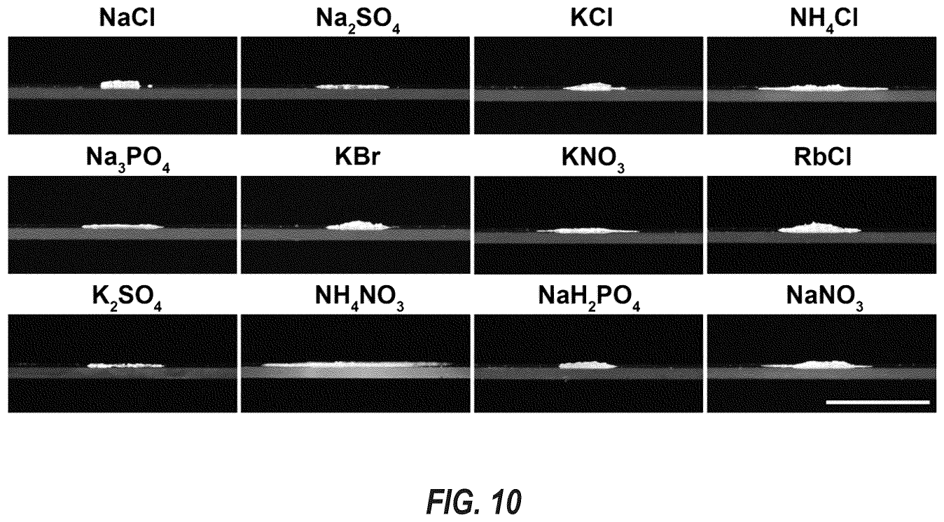

FIG. 4 further shows representative deposit patterns of the twelve key salts. The deposits show differences that are striking enough to suggest the possible identification of the salt from the macroscopic pattern. For instance, NaCl and KBr form a few small crystals (B,G) while others generate patterns with a noticeable ring near the original drop border (Panels C, F, H, J). Despite this similarity, the latter four salts differ by the interior structure which can involve needles (Panels F, H) or small deposits (Panels C, J), as well as the shape of the deposits outside of the ring. In (Panel H), these outside features lead to deposit borders far beyond the original drop border. This creeping behavior is also found in (Panels E, K, M) but a ring is absent and the borders differ in roughness. Differently rugged borders are also seen in (Panels D, I, L). Sub-millimeter features and side views of the deposits are shown in FIG. 9 and FIG. 10.

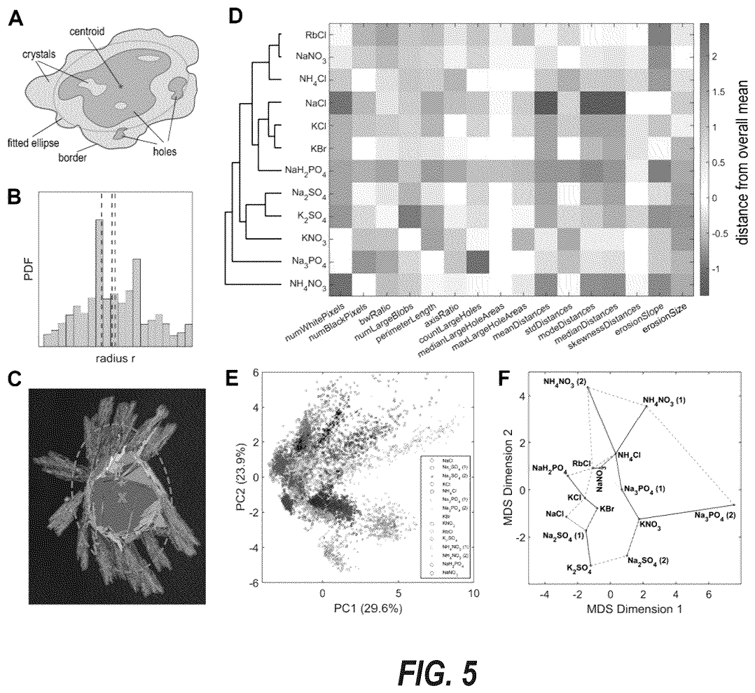

FIG. 5 illustrates image analysis and a family tree of salt deposits. Panel A illustrates a schematic drawing of a deposit pattern with deposit-free holes. Curves denote deposit borders and the best-fit ellipse yielding eccentricity data. Panel B illustrates Radial distribution of deposit distances from the pattern centroid. Lines indicate the corresponding mode, mean, and median values. Panel C illustrates an example analysis applied to the KNO₃ example in FIG. 4. Panel D illustrates a heatmap of the 16 image metrics for 12 different salts. The data yield a dendrogram of similar deposit patterns. Panel E illustrates 6000 deposit patterns analyzed and projected into the plane spanned by the two most dominant principal components PC1 and PC2, which account for 54% of the information. Different salts are represented by different shading; different markers of the same shade distinguish pattern types of the “bifurcated” salts (e.g. Na₂SO₄ (1; dominant) and (2; subtype)). Panel F illustrates multidimensional scaling map of the centroids of the data groups in Panel E. Lines connect closest and second-closest neighbors, respectively.

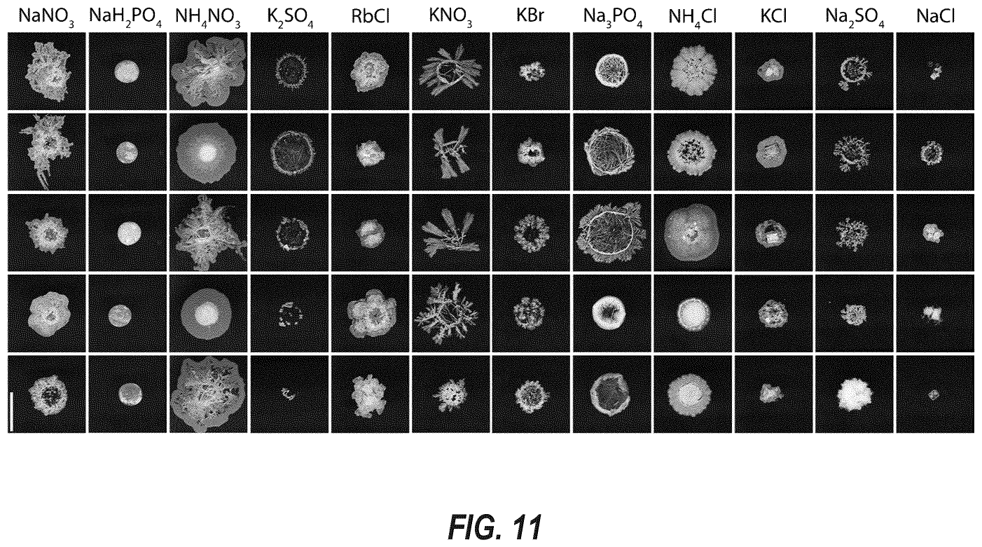

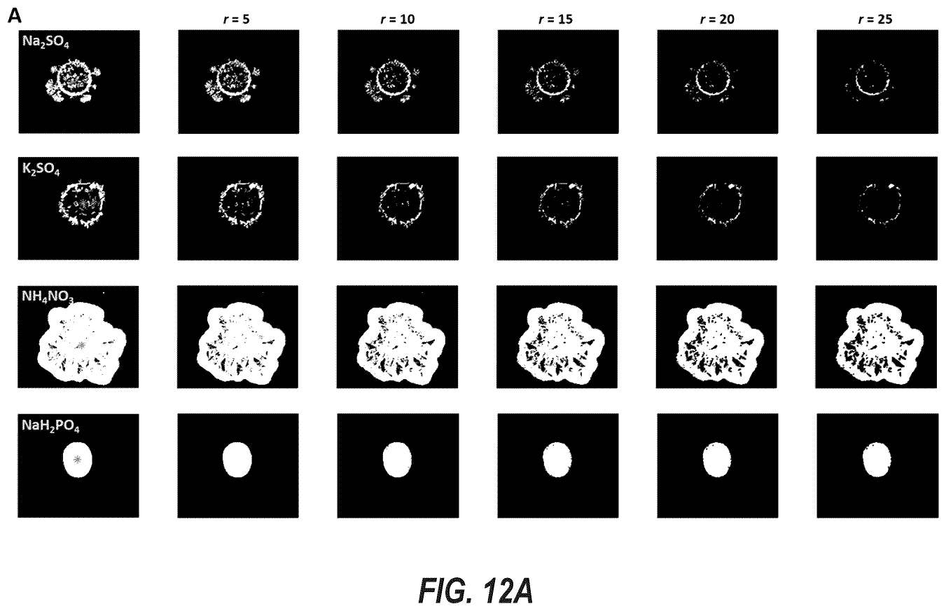

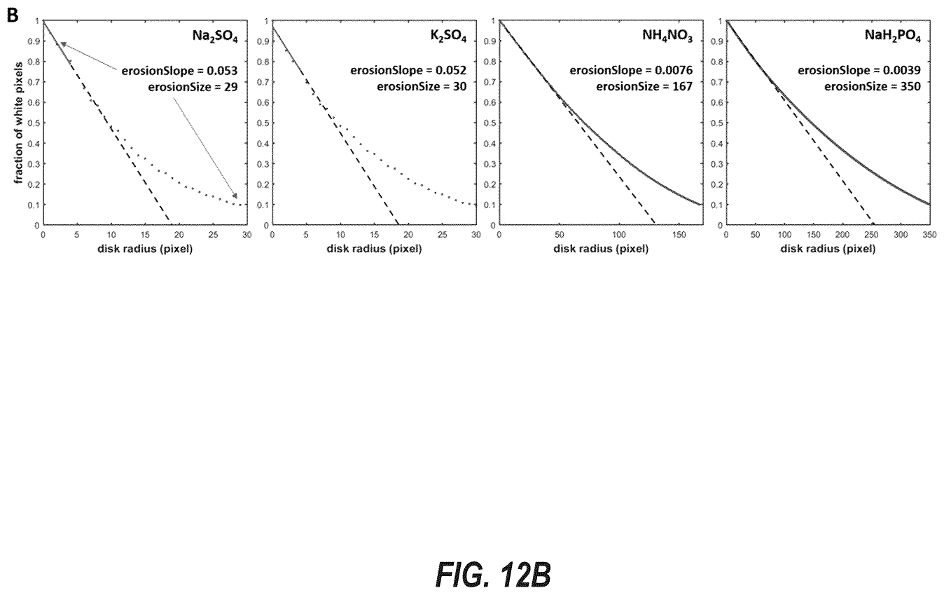

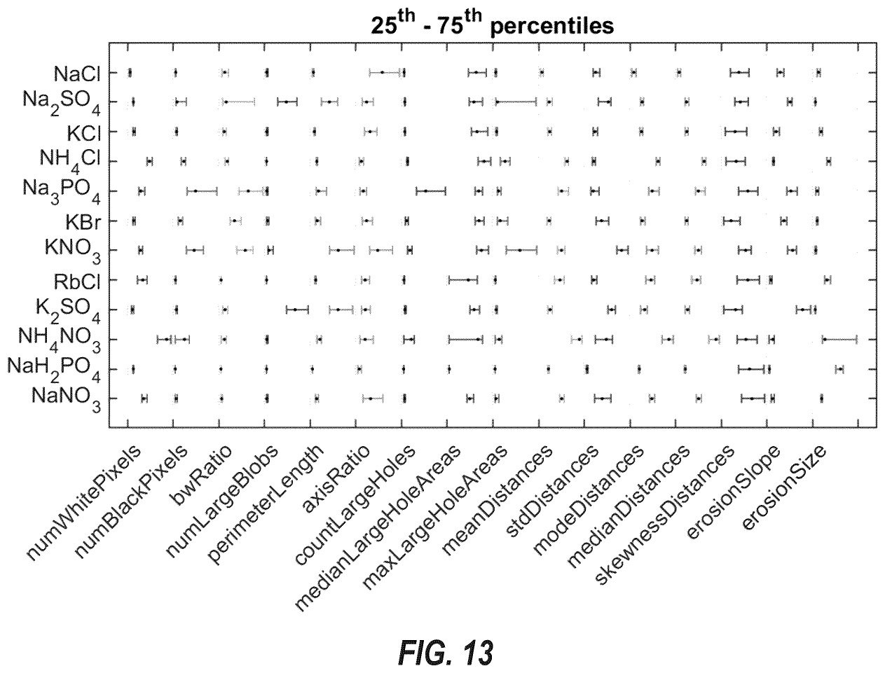

The differences in FIG. 4 can be placed in the context of the natural variation of the patterns associated with a given salt. As a qualitative reference point, FIG. 11 shows additional examples for each of the 12 salts. To establish a quantitative approach, the study extracts 16 different parameters from each deposit picture that are listed and partially illustrated in FIG. 5. All parameters are computed from binary versions of the recorded images that-according to a constant intensity threshold-distinguish between the bright salt locations (white “1”) and the dark background (black “0”). These binary images are also analyzed for their spatially connected “1” and “0” areas and ultimately yield variables such as the total salt area (numWhitePixels), the total area of salt-free holes (numBlackPixels), their ratio (bwRatio), the number of connected salt areas (numLargeBlobs), and the eccentricity of the salt area based on a fitted ellipse (axisRatio) shown in Table S1. Several other parameters are determined from the distribution of white-pixel distances from their centroid and the erosion response of the binary image (i.e., the elimination of small details, shown in FIGS. 12A-12B) Once these metrics are found for all 12×500 images, each metric was normalized as the distance from the respective mean, measured in standard deviation units as shown in FIG. 13. These Z-scored data represent each deposit image as a point in a 16-dimensional morphospace. Within this data set, the different salts form subsets with averages that differ from the global zero mean. These averages are shown as a heatmap in FIG. 5. Inspection of the leftmost column shows red squares for NH₄NO₃, NH₄Cl, NaNO₃, and RbCl which correspond on average to the largest deposit areas. Notice that RbCl in FIG. 4 is not that expansive but other RbCl drops can deposit over large areas as shown in FIG. 8. Other notable features include a large number of deposit-free holes for Na₃PO₄ and a very small mean distance for NaCl.

Based on these results, the study computed the centroids for each salt in the 16-dimensional analysis space and evaluate their respective distances. This procedure is used to calculate a dendrogram expressing the closest similarities between salts and groups of salts shown in FIG. 5. Based on image data, the dendrogram formulates salt families such as the NaCl—KCl—KBr group showing compact deposits with small crystals. Another family is the RbCl—NaNO₃—NH₄Cl group of creeping salts shown in FIG. 5 which is distant from the fourth creeping salt NH₄NO₃ which stands out as its own category.

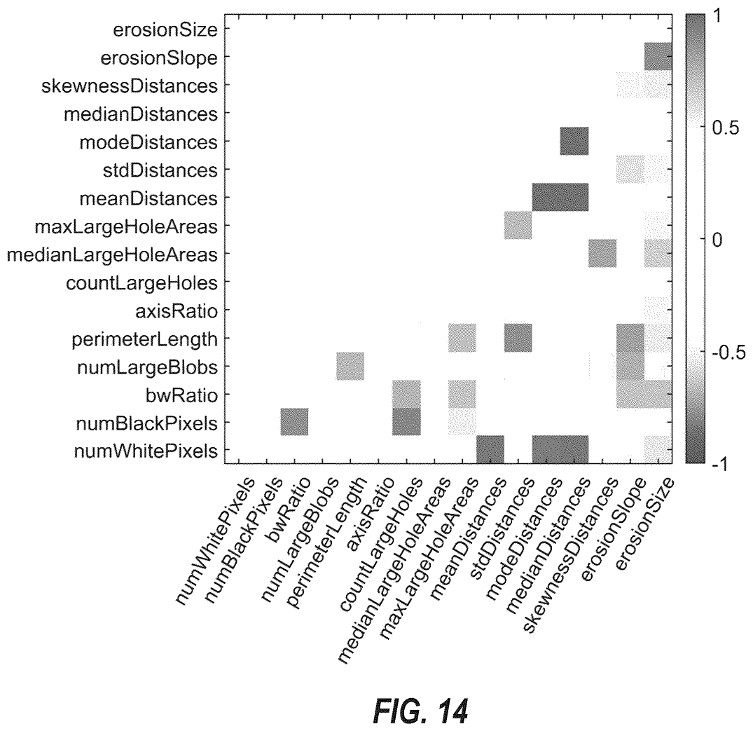

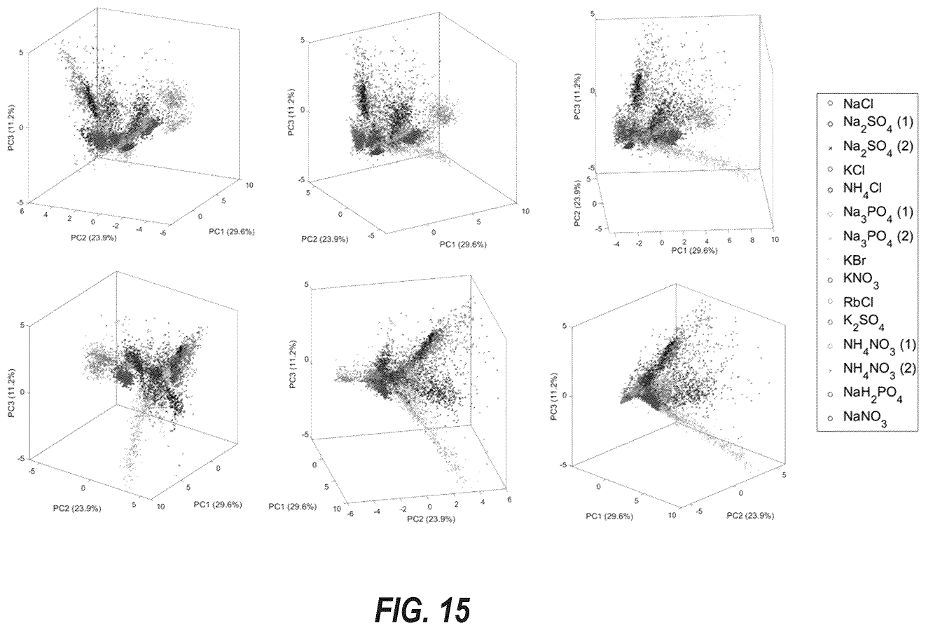

For the given set of salts, some of the 16 metrics strongly correlate such as the mean and median distances (FIG. 13, FIG. 14) which have a correlation coefficient of c=+0.9997. The study also found anti-correlation between variables such as the median area of the deposit-free holes and the skewness of the distribution of deposit-centroid distances (c=−0.7159). This possible redundancy in the analysis suggests a dimensional reduction of the 16-dimensional space by principal component analysis (PCA). FIG. 5 further illustrates the projection of all 6000 data points onto the plane spanned by the first and second principal components. Despite the large number of salts and variations between the deposit patterns of a given chemical, the salts are surprisingly well separated with only little overlap. This overlap further decreases when additional PCA dimensions are added as shown in FIG. 15.

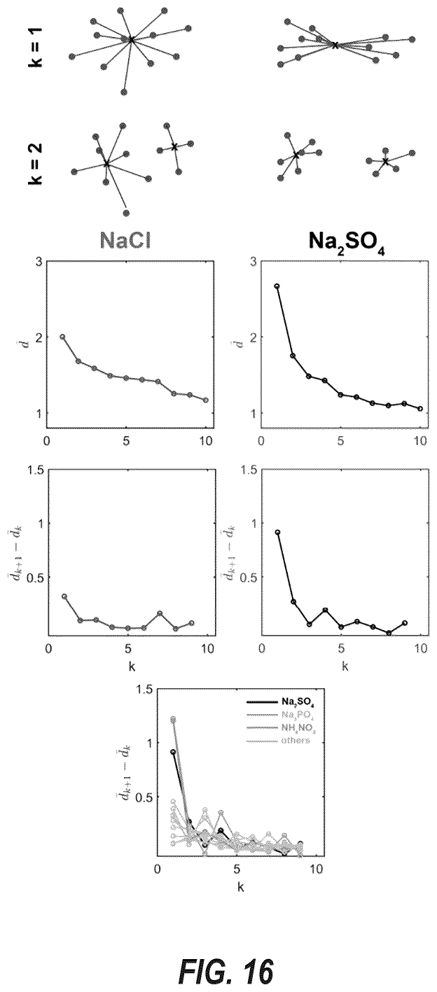

In addition, our PCA results indicate that some salts form two qualitatively distinct types of deposit patterns (see e.g. black markers for Na₂SO₄ in FIG. 5). Further cluster analysis shown in FIG. 16 confirms that Na₂SO₄, Na₃PO₄, and NH₄NO₃ should indeed be treated as such “bifurcated salts”. For example, identical NH₄NO₃ drops create pattern types that either have a very large deposit area with an irregular border (dominant type) or tend to be slightly smaller with a fried-egg appearance (secondary type) as shown in FIG. 11. The physical mechanism giving rise to these different deposit subtypes at constant experimental conditions is closely related to the stochastic process of crystal nucleation in small solution volumes. More specifically, the study found that the smaller fried-egg patterns occur for drops that start crystallization tens of minutes after the drops giving rise to the larger irregular deposits. These observations point towards an increased level of super-saturation in the late crystallizers and will require future studies.

The study further performed multidimensional scaling (MDS) analysis which is a commonly used visualization technique to present the information contained in a distance matrix. For this, the study computed the centroids of each of the 12 salts and three additional subtypes in the 16-dimensional space of the Z-scored image metrics. MDS now represents the Euclidian distances d between the 16+3 centroids in a plane while minimizing the stress (s=0.064) on the projection. The MDS map in FIG. 5 shows the corresponding results with solid lines connecting salts that are closest pairs. Notice that the latter relationship is not necessarily mutual as, for instance, NaCl is closest to KCl (d=1.31), but KCl is closer to KBr (d=0.91). Furthermore, the study found the closest distance (d=0.35) for NaNO₃ and RbCl illustrating that no simple chemical relationships can be formulated from purely compositional arguments. The same holds for the respective crystal structures which are expected to be trigonal or rhombohedral for NaNO₃ and cubic for RbCl.

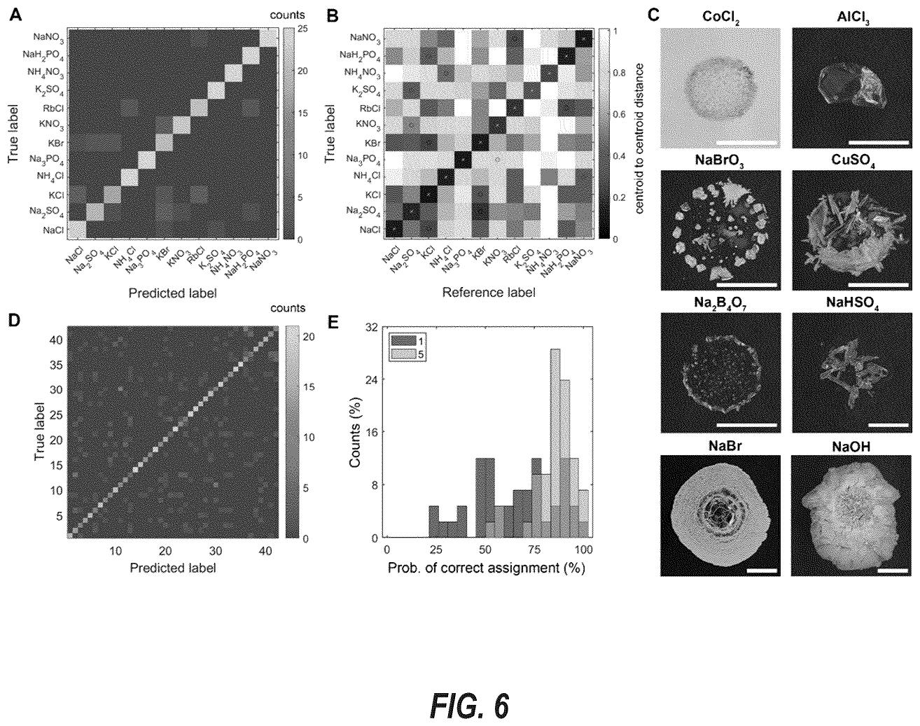

FIG. 6 illustrates identification of composition from deposit patterns. Panel A shows a confusion matrix with each square showing the number of predictions for each salt based on 25 deposit patterns that were not included in the training data set of 6000 images. Panel B illustrates a heat map where each set of 25 reference images is collectively analyzed for its normalized distance to the centroids of salt patterns in the main data set. White x-markers and black o-markers denote the closest and second-closest matches, respectively. Panel C illustrates deposit patterns of eight additional salts. All scale bars are 500 μm. Panel D illustrates a confusion matrix of 42 different salts (see appendix for compound indices) as obtained for a very small set of 21 images per salt. Panel E illustrates a distribution of the diagonal values of the confusion matrix in Panel D and a comparison group of random guesses.

The results illustrated here show applications of the example implementation of the present disclosure as an inexpensive and purely image-based chemical analysis technique. The study considered, for each of the 12 key salts, 25 additional deposit images that were not included in the prior analyses. These images are processed as before yielding 12×25=300 new metric vectors for testing. The study then predicted the salt composition by a direct vector-based comparison between the query image and all 6000 reference vectors. The closest agreement, i.e. the shortest distance in the 16-dimensional morphospace, yields the predicted assignment for the test image. FIG. 6 shows the resulting confusion matrix as a heatmap. Here the vertical axis specifies the true salt, the horizontal axis denotes the predicted salt name, and the colors represent the number of predictions (i.e. a value between n=0 and 25). The study found that most predictions are correct as indicated by the diagonal, which is the most frequent value within the row. The most likely misidentifications occur for KCl which is mistaken as NaCl (n=3), KBr (n=2), and RbCl (n=3). The overall success rate is 90%.

The reliability of this approach can be further increased by combining the information of the 25 test images into one single identification request. This grouping is performed by averaging the 25 individual centroids. Computation of the Euclidian distances between the averaged centroid to the 12 reference centroids yields the results in FIG. 6 where colors indicate the normalized distances. The study found the smallest distances (dark squares) reliably along the diagonal which implies the correct identification for all test groups.

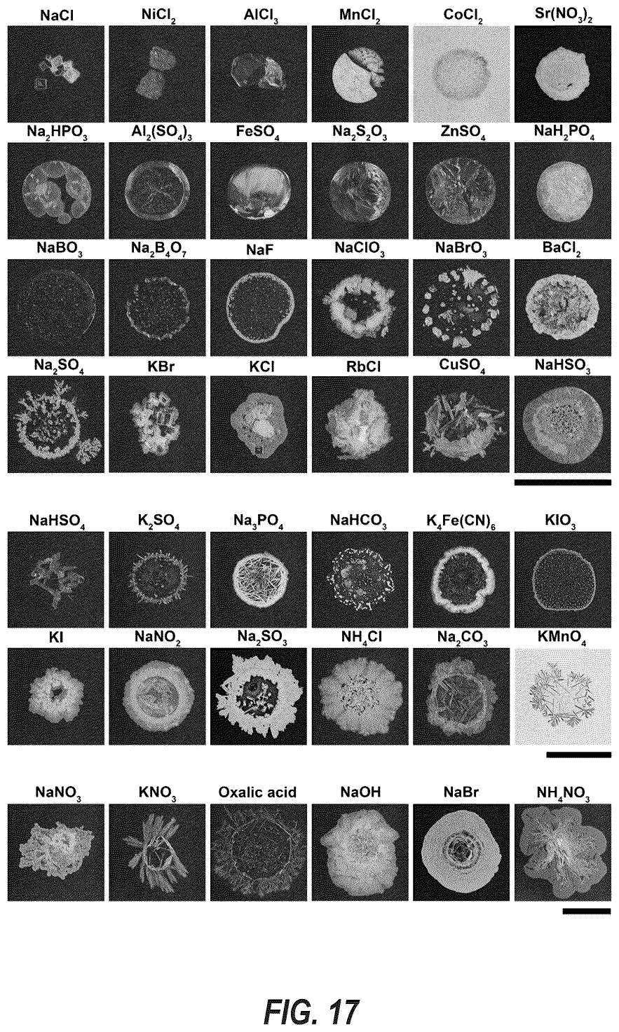

Next, the study expanded the number of analyzed pure salts from 12 to 42 but under the constraint of a greatly reduced sample size. FIG. 6 and FIG. 17 show deposit patterns of these salts that complement the examples shown FIG. 4 and FIG. 11. These new salts expand the observed variety of patterns but still align well with the earlier discussed families. Specifically, NaBr, NaOH, Na₂CO₃, Na₂SO₃, and oxalic acid (the only organic compound in this study) are identified as creeping salts, whereas NaBO₃, Na₂B₄O₇, NaF, K₄Fe(CN)₆, and KIO₃ produce clear ring-shaped patterns. Furthermore, Na₂HPO₃, while similar to those salts that form a nearly homogeneous deposit, shows an intriguing segmentation structure consisting of partially overlapping disks and half-disks.

For each of these 30 additional salts, the study recorded and processed 21 deposit patterns yielding 630 morphospace vectors. These data are complemented by 21 randomly chosen analysis vectors for each of the original 12 salts yielding a new combined data set of 42×21=882 vectors. FIG. 6 shows the corresponding confusion matrix with the true and predicted salt identity on the vertical and the horizontal axes, respectively. Unlike the procedure for FIG. 6 the study compared each of the vectors against all others to find the shortest Euclidian distance in the morphospace and the corresponding prediction. Accordingly, both the maximum possible value of the matrix cells as well as the sums across each row are 21. Again, the study finds excellent predictive power as shown by the the matrix diagonal. The most reliable predictions were made for CoCl₂, NaBrO₃, and Na₂B₄O₇. The weakest results are obtained for AlCl₃, CuSO₄, and NaHSO₄ (all shown in FIG. 6) which show pronounced variability in the individual deposit patterns, which complicates identification.

FIG. 6 takes a closer look at the results of the 42-salt predictions by graphing the percentage of successful predictions based on the confusion matrix in FIG. 6. The bars show the likelihood of a correct, single-trial prediction, which varies between about 24 and 100% with an average of 65%. The bars show the same probabilities if allowing five attempts for the correct prediction, which increases the prediction accuracy to 85%. For comparison, random guesses would yield success rates of 2% and 12% for one and five trials, respectively. Identifying a select group of salts as the most probable contenders can be highly beneficial, particularly as certain salts may be improbable candidates in specific applications.

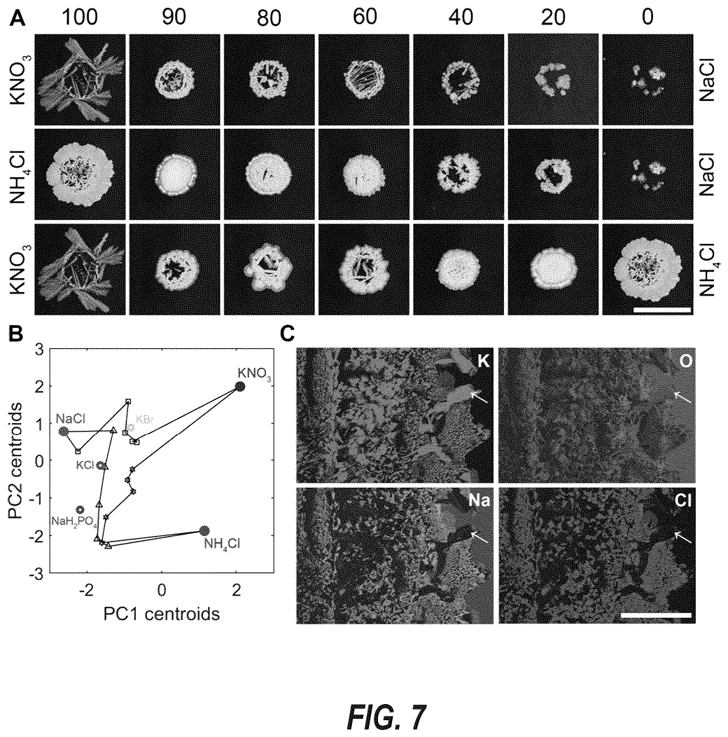

FIG. 7 illustrates deposit patterns of binary salt mixtures. Panel A illustrates typical deposit patterns observed for drops containing two dissolved salts. The numbers above each column denote the percentage volume of the saturated salt solution specified on the left as mixed with the saturated salt solution on the right. The scale bar is 1 cm and applies to all panels. Panel B illustrates a projection of the salt mixture patterns into the PCA plane of FIG. 6. Each open marker represents the average coordinates obtained from 30 images. These markers trace the deposits' changes as the mixing ratio is varied. Squares, triangles, and stars indicate KNO₃/NaCl, NH₄Cl/NaCl, and KNO₃/NH₄Cl mixtures, respectively. Solid markers indicate pure deposit coordinates for reference. (C) EDS maps of the magnified deposit area produced by a KNO₃/NaCl drop (60:40 v/v). The panels show the spatial distribution of the specified elements (K, O, Na, and Cl). Scale bar: 500 μm.

To obtain insights into the behavior of salt mixtures, the study investigated different solutions of NaCl/NH₄Cl, NaCl/KNO₃, and NH₄Cl/KNO₃. These binary mixtures are produced from the respective saturated pure solutions at different volume fractions. No precipitation is observed during mixing. FIG. 7 shows representative deposit patterns formed by these binary mixtures where the numbers above each column indicate the percentage volume fraction (e.g. the upper left panel is pure KNO₃). The deposit patterns are very sensitive to small changes away from the pure state. In addition, the tested mixtures often create ring-shaped and disk-shaped patterns similar in size to the original drop. Strong sensitivity to small compositional variations was also observed by adding small amounts of Fe(CN)₆ to NaCl solutions with the result of very strong creeping behavior due to faster nucleation and growth of nonfaceted microcrystals. [34]

The study analyzed the deposit images of these binary pairs using the test method used for FIG. 6. This method—which was not trained on mixtures—mistakes the deposits as pure compounds that always differed from the original constituent salts. For the example of NH₄Cl/KNO₃, several mixtures are assigned to KCl, which is a possible precipitation product considering the involved ions and solubilities which are 3.78, 4.55, and 7.16 mol/L for KNO₃, KCl, and NH₄Cl, respectively.

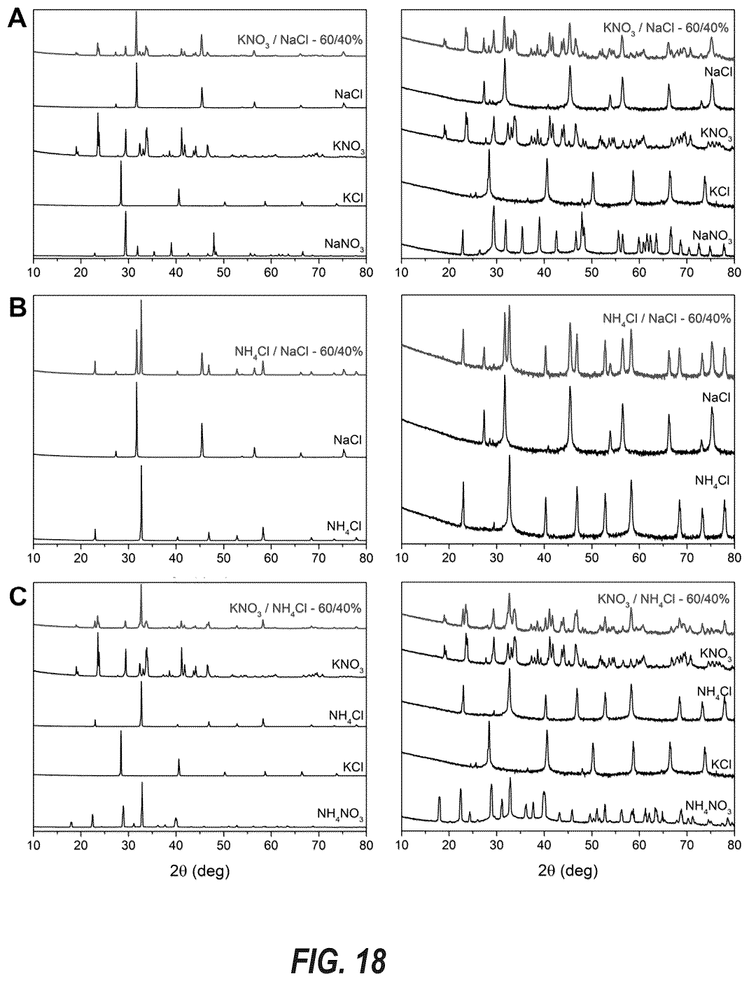

To resolve the actual composition of the deposits, the study performed X-ray diffraction (XRD) measurements on these samples. The XRD patterns reveal a high degree of crystallinity and identify the products as mixtures of the original salts shown in FIG. 18. Essentially no KCl is detected for the deposit patterns of NH₄Cl/KNO₃ mixtures, but other salt combinations can be expected to yield products that differ from the originally dissolved compounds.

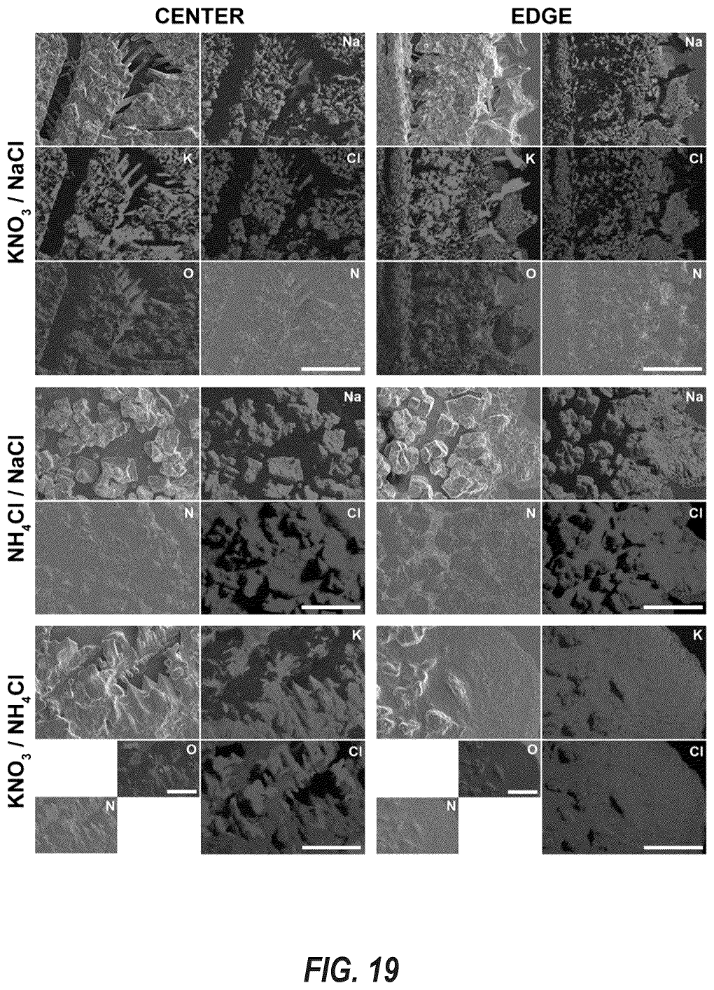

Another aspect of mixed salt deposits is the potential variation of their spatial distribution. For the NaCl/NH₄Cl, NaCl/KNO₃, and NH₄Cl/KNO₃ pairs (volume fraction 60:40), energy dispersive spectroscopy (EDS) reveals no macroscopic separation of the products within the deposit pattern. However, as illustrated in FIG. 7 for the example of KNO₃/NaCl (see also FIG. 19), the crystalline products are spatially separated at length scales of hundreds of micrometers. The spatial K—O and Na—Cl pairings persist throughout the maps (see arrows). Shorter separation scales are found only for some featureless deposit sections where the crystallites are much smaller.

The deposit patterns of the mixtures can be further analyzed as paths connecting the pure salts in the PCA space. The results for the first and second principal components are shown in FIG. 7 where the markers denote the centroids (i.e. the most characteristic) pure salt patterns. The small markers are the centroids of the mixed deposits, each obtained from 30 images, as projected into the principal component plane. These markers are connected by lines in the order of the mixtures' volume fractions and show that the morphological connections deviate strongly from simple linear paths. The plot is complemented by the centroids of the pure salts that appeared in the aforementioned identification attempts.

FIG. 7 shows several mixtures cluster near the location of pure KBr and an otherwise unremarkable position near the coordinates (−2,−2). These positions can be characterized as a small aggregate of crystals and a small disk of nearly homogeneous deposits. The latter pattern consists of a multitude of very small crystals and might result from the effects of added “foreign” ions on crystal nucleation and growth.

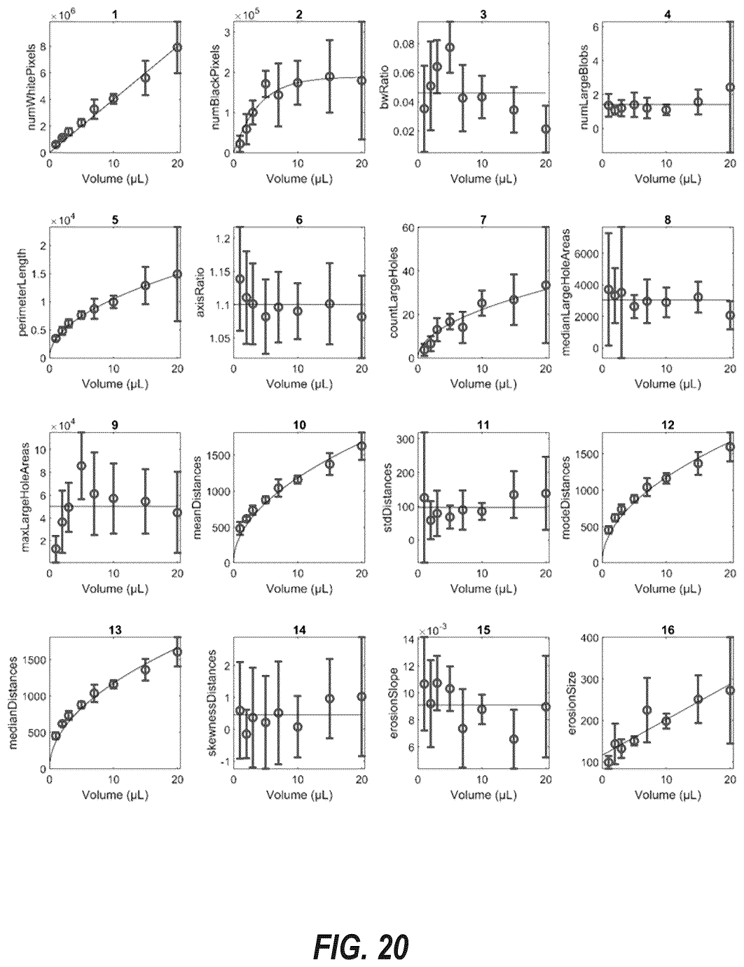

The findings presented thus far have been derived from experiments using an initial droplet volume of V₀=10 μL. To explore the effect of volume changes, the study conducted 240 experiments using saturated NH₄Cl solutions across a range of eight different V₀ values between 1 and 20 μL. The analysis of the patterns formed by the resulting deposits reveals intriguing relationships between the 16 evaluated metrics and V₀ shown in FIG. 20. These relationships can be categorized into four distinct classes. For instance, certain metrics, such as the total area of the deposit (numWhitePixels), show a linear increase with larger initial volumes, yielding a slope of 10.8 mm⁻¹ upon data calibration. Others, like the perimeter length and the mean distance, illustrated in FIG. 5, demonstrate a square root dependence on initial volume. Meanwhile, some metrics show no dependence on V₀ (e.g., numLargeBlobs), or display an initial rise followed by saturation or decline (e.g., bwRatio). These observations are likely influenced by the specific salt used in the experiments and promise to offer deeper insights into the mechanisms at play.

### Discussion

The deposit patterns described in this study show a spectrum of shapes and phenomena that emerge from the interplay of numerous physicochemical processes. Crystallization can spread out the solution via capillary action or confine it by the construction of permanent or intermediate barriers. Crystal habits, temperature changes, and surface-dependent evaporation rates further complicate this picture. In addition, some of these processes are intrinsically stochastic such as the nucleation of crystallites causing unavoidable variations between the self-organized patterns. Despite these variations, clear similarities exist between the deposits of a given salt that hint toward hidden empirical laws.

Table S2 compares the identified pattern families (see dendrogram in FIG. 5) with relevant physical constants such as the solubility, density, crystal structure, equilibrium relative humidity, and enthalpy of solution. NH₄NO₃ has the highest solubility by far and occurs in the family tree as the most isolated salt. Of the three other creeping salts, which form a distinct family in the dendrogram, the solubilities of two are also high but for one, NH₄Cl, it is relatively low and more in line with the related NaCl—KCl—KBr family. Most surprisingly, however, cubic crystals appear exclusively in the upper half of the family tree with the hexagonal NaNO₃ being the only exception. No obvious trends were found for the enthalpy of solution, but the Na₂SO₄—K₂SO₄ pair has identical densities at the high end of the data.

The intriguing links between pattern-based families and physicochemical data will require additional work to discern between mere correlations and predictive causal relationships. However, our study already demonstrates predictive capabilities in the opposite direction, i.e. the prediction of the salt composition from the deposit pattern. The study anticipates that sufficiently large databases will allow the rapid and reliable photo-based identification of chemical composition from various solution drops dried under controlled conditions.

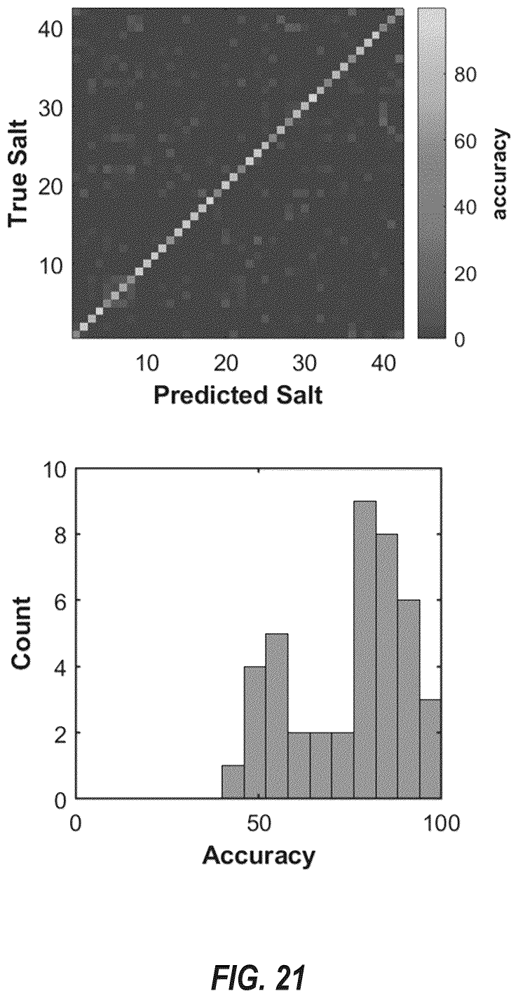

While the study already includes about 7,500 images, future work will require a significant expansion of the available images involving more compounds, mixtures, and conditions. Lab automation techniques [35] can play a role in this process. Further improvements will result from machine learning (ML) and artificial intelligence (AI) which are known to excel in image classification. [36]A first step in this direction is shown in FIG. 21 which uses a decision-tree method [37, 38] on a severely reduced database of 14 training vectors for each of the 42 salts. Despite this very small training set, the ML method yields a prediction accuracy of 75%.

Given the unique “fingerprint” nature of salt deposits and today's powerful ML/AI techniques, the implementations of the present disclosure described herein can include a broad spectrum of applications, from phone apps to novel instrumentation supporting food and laboratory safety, analytical chemistry, and even space exploration. These applications will not only benefit from the streamlined image reduction to concise vectors, facilitating rapid and efficient computational analyses but also enable the examination of extremely small sample quantities.

### Experimental Methods

The study prepared saturated solutions by continuously adding and stirring the respective salt into high-purity water (resistivity of 18.3 MΩ cm) until no further solute could be dissolved as indicated by the presence of undissolved salt particles. After a few hours, using an Eppendorf pipette, the study placed three 10 μL drops of the saturated solutions onto a horizontal microscope slide (VWR; 7.5×2.5 cm soda lime glass). After 6-12 h, the study recorded pictures of each white deposit pattern using a Nikon D3300 camera equipped with a macro lens (Tamron, 90 mm f/2.8). The samples were illuminated by diffuse, white ceiling light or a ring of diffused, white LED lights around the sample. All experiments were carried out at ambient conditions (21° C., 40-50% RH).

The image analyses were conducted using MATLAB programs, with the main analysis script provided as Supplementary Material. All images had a resolution of 6000×4000 pixels at a constant magnification of 5.2 μm/pixel. SEM-EDS measurements were performed on a FEI Helios G4 UC instrument at an acceleration voltage of 20 kV and for a working distance of 5 mm on Pd-coated samples (10 nm thickness). For some dried samples, the study performed X-ray diffraction and micro-Raman spectroscopy. The XRD samples were collected by scraping 25 deposit patches per salt off their microscope slides and grinding the material with a mortar and pestle. Additional information on chemicals and methods is provided in the Supplementary Materials.

### APPENDIX

The indices and structural formulae of the 42 salts in FIG. 7 are: (1) NaCl, (2) Na₂SO₄, (3) KCl, (4) NH₄Cl, (5) Na₃PO₄, (6) KBr, (7) KNO₃, (8) RbCl, (9) K₂SO₄, (10) NH₄NO₃, (11) NaH₂PO₄, (12) NaNO₃, (13) CuSO₄, (14) CoCl₂, (15) KMnO₄, (16) NaHCO₃, (17) NaBr, (18) NaF, (19) NaNO₂, (20) NaHSO₃, (21) NaHSO₄, (22) Na₂B₄O₇, (23) NaBrO₃, (24) NaClO₃, (25) KI, (26) KIO₃, (27) K₄Fe(CN)₆, (28) BaCl₂, (29) Na₂SO₃, (30) Sr(NO₃)₂, (31) (COOH)₂ (oxalic acid), (32) Na₂HPO₃, (33) FeSO4, (34) Al₂(SO₄)₃, (35) NaBO₃, (36) Na₂S₂O₃, (37) AlCl₃, (38) Na₂CO₃, (39) NaOH, (40) MnCl₂, (41) NiCl₂, and (42) ZnSO₄.

### Experimental Section:

The following section provides additional information on the used chemicals and methods complementing the description in the main paper.

The initial footprint area of the drops was independent of the salt used showing only minor variations between experiments.

The study collected optical micrographs with the help of an trinocular microscope under white light illumination created by several LEDs arranged around the sample.

FIG. 8 illustrates time sequences showing the drying process for the 12 key salts. Each row corresponds to an example recorded for the salt specified on the left. The time elapsed between the first and last frame is shown on the right and the frames of a given row are spaced at constant time intervals equaling that time divided by four. Notice that NaH₂PO₄ creates an essentially instantaneous salt ring that subsequently vanishes. The scale bar applies to all image panels and corresponds to 1 cm. The dynamics of the evaporation process and the salt deposition are also shown in Movie 51.

FIG. 9 illustrates optical micrographs of the deposit patterns of 12 different salts. The three main columns correspond to different magnifications. For each salt and magnification, two different examples are shown next to each other. All scale bars: 1 mm.

FIG. 10 illustrates side views of dried deposits indicating differences in shape as well as vertical and horizontal size. The band in each image is the edge of the glass slide. The scale bar applies to panel and is 1 cm.

FIG. 11 illustrates examples for the deposit patterns created by 10 μL drops of aqueous solutions of the specified salts. The first column shows the same photos as FIG. 4, which were selected based on the very close vicinity to the salts' centroids in the analysis space. The examples in the other columns were selected by qualitative, visual inspection to present a cross-section of the most frequent pattern forms. The scale bar applies to all figure panels and represents 1 cm.

Table S1, below, shows a description of 16 example Image Measures that can be used for image processing in implementations of the present disclosure. It should be understood that these measures are non-limiting examples, and that other image processing techniques can be used in implementations of the present disclosure. The following information specifies the image metrics that are extracted from each sample. The list follows the order shown in FIG. 5. The analysis starts with high-resolution raw images (6000×4000 pixels, 3.12×2.08 cm²) that are converted to 8-bit grayscale images and then binary images. The latter step compares the local grayscale value to a constant threshold (74) yielding “₀” (black) for the dark background and “1” (white) for the salt deposit. The binary images are further processed with MATLAB's blob analysis tools which provide information on the connected white and black regions. Notice that very small white regions measuring less than 1400 pixels (0.038 mm²) are not considered as they likely represent dust. The image features shown in Table S1 are intended only as non-limiting examples, and additional example image features are listed above, for example.

TABLE S1

| | Descriptor: Variable Name | Explanation |
|---|---|---|
| 1 | Number of White Pixels: | This measure is the total count of white pixels. It |
| | numWhitePixels | specifies the total deposit area. |
| 2 | Number of Black Pixels: | This measure is the total count of black pixels within |
| | numBlackPixels | regions surrounded by white pixels. Notice that this |
| | | quantity is sensitive to small gaps in the white regions |
| | | that connect the black region to the global background. |
| | | If such a gap exists the black area is not analyzed. |
| 3 | Ratio of Black to White | This measure is the ratio of the pixel counts in 2 and 1. |
| | Pixel Counts: bwRatio | |
| 4 | Number of Connected | This measure is the total number of connected white |
| | White Areas: | areas. |
| | numLargeBlobs | |
| 5 | Boundary Length of | This measure is the sum of the perimeter lengths of all |
| | Connected White Areas: | connected white areas. For a given total white area it |
| | perimeterLength | increases with numLargeBlobs and the eccentricity of |
| | | the individual blobs. |
| 6 | Eccentricity of White Area: | This measure is the eccentricity as calculated from the |
| | axisRatio | best-fit ellipse for all white pixels. Values larger than |
| | | one indicate that the deposit deviates from a circular |
| | | disk. |
| 7 | Number of Connected Black | This measure is the number of black connected areas |
| | Areas: countLargeHoles | (holes) larger than 1000 pixels. |
| 8 | Median Area of the | This measure is the median value of the black |
| | Connected Black Areas: | connected areas (holes) larger than 1000 pixels. |
| | medianLargeHoleAreas | |
| 9 | Maximum Area of the | This measure is the maximum value of the black |
| | Connected Black Areas: | connected areas (holes) larger than 1000 pixels. |
| | maxLargeHoleAreas | |
| 10 | Mean Distance of All White | This measure is the average of the distances |
| | Pixels from the Centroid: | of all white pixels from their common centroid |
| | meanDistances | (see FIG. 5). |
| 11 | Standard Deviation of All | This measure is the standard deviation of the distances |
| | White-Pixel Distances from | of all white pixels from their common centroid (see |
| | the Centroid: stdDistances | FIG. 5). |
| 12 | Mode of all White-Pixel | This measure is the most frequent value among the |
| | Distance from the Centroid: | distances of all white pixels from their common |
| | modeDistances | centroid (see FIG. 5) Notice that the likelihood of a |
| | | certain distance tends to increase with increasing |
| | | values. |
| 13 | Median Distance of All | This measure is the median of the distances of all white |
| | White Pixels from the | pixels from their common centroid (see FIG. 5). |
| | Centroid: medianDistances | |
| 14 | Skewness of The | This measure is the degree of asymmetry observed in |
| | Distribution of All White- | the distribution of the distances of all white pixels from |
| | Pixel Distances from the | their common centroid (see FIG. 5). Zero implies a |
| | Centroid: | symmetric distribution, whereas positive (negative) |
| | skewnessDistances | values indicate that the distribution is skewed to the |
| | | right (left), meaning that the majority of white pixels |
| | | are located further from (closer to) the centroid on |
| | | average. |
| 15 | Erosion Rate of White | The study computed the fraction of remaining white |
| | Pixels: erosionSlope | pixels f after erosion with disks of radius r. The slope |
| | | of f(r) for small disk radii (0-4 pixels) defines this |
| | | measure. Large values indicate the presence of fine |
| | | details in the deposit pattern. |
| 16 | Disk radius required to | The study computed the fraction of remaining white |
| | erode 90% of all Original | pixels f after erosion with disks of radius r. The smallest |
| | White Pixels: erosionSize | disk radius for which f(r) ≤0.1 defines this integer |
| | | measure. Large values indicate compact deposit |
| | | patterns such as featureless white disks. |

FIG. 12A illustrates image erosion behavior for the patterns illustrated for four salts, including the original threshold-processed deposit patterns. The other columns show the images after erosion with a disk structuring element of radius r. The disk radius in pixel is specified above the columns and the salts are specified for each row. FIG. 12B illustrates an example of how the erosion causes the progressive thinning and reduction of image features, which is quantified by following the ratio of the remaining white pixels in the eroded images relative to the original. Based on this curve, the image metric “erosionSlope” denotes the initial decrease. The image metric “erosionSize” equals the disk radius required for removing 90% of the original white pixels. Calibration for all images: 1 pixel=5.2 μm.

FIG. 13 illustrates median (dots) and 25^{th}-to-75^{th} percentiles (error bars) for the 12 different salts and 16 pattern metrics. Each salt is represented by the analysis results of 500 images. Notice that the metrics are Z-scored with respect to all 6000 samples to yield a global average and standard deviation of 0 and 1, respectively.

FIG. 14 illustrates the correlation coefficients between the different Z-scored metrics as measured from the 6000 images of the 12 key salts. Some metrics show strong positive correlations (squares) such as meanDistances and numWhitePixels, while others are anti-correlated (squares) such as erosionSlope and erosionSize. This type of correlation analysis can guide future developments of advanced evaluation metrics and ensure efficient representations without unwanted redundancies.

FIG. 15 illustrates an analysis of 6000 deposit patterns that were projected into the space spanned by the three most dominant principal components PC1, PC2, and PC3, which account for 65% of the information. Different salts are represented by different colors according to the legend; different markers of the same color distinguish pattern types of the “bifurcated” salts (e.g. Na₂SO₄ (1; dominant) and (2; subtype)). The panels only differ in their respective viewpoints. These plots complement the two-dimensional PCA projections in FIG. 5.

FIG. 16 illustrates identification of “bifurcated” salts. For each salt, the study performed a cluster analysis that determines the average distance d under the assumption of k clusters. Panel A illustrates schematics illustrating the distances (lines) for a hypothetical one-cluster point group (left) and two-cluster point group (right) for k=1 (top) and k=2 (bottom). The x-markers denote the centroids. The resulting average distance for k=2 is always smaller than for k=1 but this difference is small for the one-cluster group compared to the two-cluster group. Panel B illustrates average distance d as a function of cluster size k for NaCl and Na₂SO₄ (top row) and the same data shown in terms of dₖ₊₁-dₖ (bottom row). Panel D illustrates the same difference data for all twelve salts. Three salts (see legend) show a big reduction in dₖ₊₁-dₖ for k=1 indicating the existence of two clusters, while the others (gray lines) do not.

FIG. 17 illustrates an overview showing representative examples of all 12 key salt and 30 additional salts. All scale bars are 1 cm and correspond to the respective image blocks.

FIG. 18 illustrates XRD patterns of the deposits formed by the three studied salt mixtures: (A) KNO₃/NaCl, (B) NH₄Cl/NaCl, and (C) KNO₃/NH₄Cl (volume ratios are 60/40 as indicated). These data are complemented by XRD data obtained from either the raw reactants or their deposits after evaporation (. For ease of comparison, the reference curves are shown twice. The left and column show the intensities on a linear and logarithmic scale, respectively. A low (possibly absent) KCl contribution is shown in panel A.

FIG. 19 illustrates SEM images and EDS maps of deposit subsections formed from evaporating drops of KNO₃/NaCl, NH₄Cl/NaCl, and KNO₃/NH₄Cl solution mixtures. The solutions were prepared by mixing saturated solutions of the two salts at a volume fraction of 60:40. SEM micrographs, sodium, potassium, oxygen, nitrogen, chlorine. The left and right column pairs show regions near the deposit patterns' center and edge, respectively. All scale bars: 500 μm.

FIG. 20 illustrates an effect of the initial drop volume on the different metrics used to characterize the deposit patterns. The data are based on 30 images for each volume of saturated NH₄Cl solutions. Error bars indicate the respective standard deviations. The black lines indicate the best fit to a constant (panels 3, 4, 6, 8, 9, 11, 14, 15), linear (panels 1, 16), square root (panels 5, 7, 10, 12, 13), or exponential function (panel 2). All distances follow a square root dependence. These results are not expected to be representative of other salts but might represent the behavior of creeping salts.

Table S2, below, shows a comparison of the dendrogram of similarities in the deposit patterns (FIG. 5) and potentially relevant physicochemical constants. Δₛₒ₁H°, M.M., and Eq. RH denote the standard enthalpy of solution, molar mass, and equilibrium relative humidity of the anhydrous salts, respectively. The latter two quantities are listed for 25° C. Except for the dendrogram in the left column, all data is taken from reference S1, except for the equilibrium relative humidity [S2]. Notice the abundance of cubic crystal structures in the upper half of the family tree.

FIG. 21 illustrates a machine learning analysis of the 42 salts based on 21 samples each. Here, the study used the random forest method with an ensemble of 100 decision trees. The method was trained on sets of 14 vectors per salt and tested with seven different vectors. Panel A shows a confusion matrix. Panel B shows distribution of accuracy values along the diagonal of the confusion matrix in panel A. The average prediction accuracy is 75%, which—considering the sample size—is very good. The method was implemented in MATLAB using the TreeBagger(100, XTrain, YTrain, ‘Method’, ‘classification’) command.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] J. Hulliger, Chemistry and crystal growth. Angew. Chem. Int. Ed. 33, 143 (1994). DOI: https://doi.org/10.1002/anie.199401431
[2] J. J. De Yoreo et al., Crystallization by particle attachment in synthetic, biogenic, and geologic environments. Science 349, aaa6760 (2015). DOI: https://doi.org/10.1126/science.aaa6760
[3] A. E. A. Allen, A. Tkatchenko, Machine learning of material properties: Predictive and interpretable multilinear models. Sci. Adv. 8, eabm7185 (2022). DOI: https://doi.org/10.1126/sciadv.abm7185
[4] Y. Zeng et al., Selective formation of metastable polymorphs in solid-state synthesis. Sci. Adv. 10, eadj5431 (2024). DOI: https://doi.org/10.1126/sciadv.adj5431
[5] G. M. Whitesides, B. Grzybowski, Self-assembly at all scales. Science 295, 5564 (2002). DOI: https://doi.org/10.1126/science.1070821
[6] O. E. Shklyaev, A. Laskar, A. C. Balazs, Engineering confined fluids to autonomously assemble hierarchical 3D structures, PNAS Nexus 2, pgad232 (2023). DOI: https://doi.org/10.1093/pnasnexus/pgad232
[7] H. Haken, Information and Self-Organization (Berlin: Springer, 1988).
[8] L. M. Barge et al., From chemical gardens to chemobrionics. Chem. Rev. 115, 8652 (2015). DOI: https://doi.org/10.1021/acs.chemrev.5b00014
[9] P. Knoll, A. V. Gonzalez, Z. C. McQueen, O. Steinbock, Flow-Induced Precipitation in Thin Capillaries creates helices, lamellae, and tubes. Chem. Eur. J. 25, 13885 (2019). DOI: https://doi.org/10.1002/chem.201903951
[10] J. M. García-Ruiz et al., Self-assembled silica-carbonate structures and detection of ancient microfossils. Science 302, 1194 (2003). DOI: https://doi.org/10.1126/science.1090163
[11] P. Knoll, B. Ouyang, O. Steinbock. Patterns lead the way to far-from-equilibrium materials. ACS Phys. Chem. Au 4, 19 (2024). DOI: https://doi.org/10.1021/acsphyschemau.3c00050
[12 ] H. P. Eugster, The beginnings of experimental petrology. Science 13, 481 (1971). DOI: https://doi.org/10.1126/science.173.3996.481
[13] M. L. Cable, T. Runĉevski, H. E. Maynard-Casely, T. H. Vu, R. Hodyss, Titan in a test tube: organic co-crystals and implications for Titan mineralogy. Acc. Chem. Res. 54, 3050 (2021). DOI https://pubs.acs.org/doi/full/10.1021/acs.accounts.1c00250
[14] S. Dai, H. Shin, J. C. Santamarina, Formation and development of salt crusts on soil surfaces. Acta Geotechnica 11, 11023 (2016). DOI: https://doi.org/10.1007/s11440-015-0421-9
[15] S. Veran-Tissoires, M. Marcoux, M. Prat, Discrete salt crystallization at the surface of a porous medium. Phys. Rev. Lett. 108, 054502 (2012). DOI: https://doi.org/10.1103/PhysRevLett.108.054502
[16] G. Licsandru, C. Noiriel, P. Duru, S. Geoffroy, A. Abou Chakra, M. Prat, Dissolution-precipitation-driven upward migration of a salt crust. Phys. Rev. E 100, 032802 (2019). DOI: https://doi.org/10.1103/physreve.100.032802
[17] R. Deegan, O. Bakajin, T. Dupont, et al. Capillary flow as the cause of ring stains from dried liquid drops. Nature 389, 827 (1997). DOI: https://www.nature.com/articles/39827
[18] Yunker, P., Still, T., Lohr, M. et al. Suppression of the coffee-ring effect by shape-dependent capillary interactions. Nature 476, 308 (2011). DOI: https://doi.org/10.1038/nature10344
[19] E. R. Washburn, The creeping of solutions. J. Phys. Chem. 31, 1246 (1926). DOI: https://doi.org/10.1021/j150278a009
[20] T. H. Hazlehurst Jr., H. C. Martin, L. Brewer, The creeping of saturated salt solutions. J. Phys. Chem. 40, 439 (1935). DOI: https://doi.org/10.1021/j150373a003
[21] B.-J. Huang, J.-C. Huang, Creeping-film phenomenon of potassium chloride solution. Nature 261, 36 (1976). DOI: https://doi.org/10.1038/261036a0
[22] N. K. Nath, N. Yasuda, W. M. Rabeh, S. C. Sahoo, P. Naumov, Structural Elucidation of the Neuraminidase Inhibitor Zanamivir (Relenza): Creeping and Diffusion for Polymorph Separation. Cryst. Growth Des. 14, 770 (2014). DOI: https://doi.org/10.1021/cg4016383
[23] W. J. P. van Enckevort, J. H. Los, On the creeping of saturated salt solutions. Cryst. Growth Des. 13, 1838 (2013). DOI: https://doi.org/10.1021/cg301429g
[24] P. Fontana, D. Pettit, S. Cristoforetti. Sodium chloride crystallization from thin liquid sheets, thick layers, and sessile drops in microgravity. J. Cryst. Growth 428, 80 (2015). DOI: https://doi.org/10.1016/j.jcrysgro.2015.07.026
[25] Y. Li, V. Salvator, H. Wijshoff, M. Versluis, D. Lohse, Evaporation-induced crystallization of surfactants in sessile multicomponent droplets. Langmuir 36, 7545 (2020). DOI: https://doi.org/10.1021/acs.langmuir.0c01169
[26] A. K. S. Kumar, Y. Zhang, D. Li, R. G. Compton, A mini-review: How reliable is the drop casting technique?Electrochem. Commun. 121, 106867 (2020). DOI: https://doi.org/10.1016/j.elecom.2020.106867
[27] D. Zang, S. Tarafdar, Y. Yu. Tarasevich, M. Dutta Choudhury, T. Dutta, Evaporation of a droplet: from physics to applications. Phys. Rep. 804, 1 (2019). DOI: https://doi.org/10.1016/j.physrep.2019.01.008
[28] https://10.1097/ICO.0000000000000467
[29] T. A. Yakhno, O. A. Sedova, A. G. Sanin, A. S. Pelyushenko, On the existence of regular structures in liquid human blood serum (plasma) and phase transitions in the course of its drying. Tech. Phys. 48, 399 (2003). DOI: http://dx.doi.org/10.1134/1.1568479
[30] H. Salim, P. Kolpakov, D. Bonn, N. Shahidzadeh, Self-lifting NaCl crystals. J. Phys. Chem. Lett. 17, 7388 (2020). DOI: https://doi.org/10.1021/acs.jpclett.Oc01871
[31] S. A. McBride, H.-L. Girard, K. K. Varanasi, Crystal critters: Self-ejection of crystals from heated, superhydrophobic surfaces. Sci. Adv. 7, eabe6960 (2021). DOI: https://doi.org/10.1126/sciadv.abe6960
[32] G. E. Budd, Morphospace. Curr. Biol. 31, R1141 (2021). DOI: https://doi.org/10.1016/j.cub.2021.08.040
[33] L. Greenspan, Humidity fixed points of binary saturated aqueous solutions. J. Res. Natl. Bur. Stand. (U. S.) 81A, 89 (1977). DOI: https://doi.org/10.6028%2Fjres.081A.011
[34] E. R. Townsend, W. J. P. van Enckevort, J. A. M. Meijer, E. Vlieg, Additive Enhanced Creeping of sodium chloride crystals. Cryst. Growth Des. 17, 3107 (2017). DOI: https://doi.org/10.1021/acs.cgd.7b00023
[35] W. Ouyang, R. W. Bowman, H. Wang, K. E. Bumke, J. T. Collins, O. Spjuth, J. Carreras-Puigvert, B. Diederich, An open-source modular framework for automated pipetting and imaging applications. Adv. Biol. 6, 2101063 (2022). DOI: https://doi.org/10.1002/adbi.202101063
[36] B. Midtvedt, J. Pineda, F. Skärberg, et al. Single-shot self-supervised object detection in microscopy. Nat. Commun. 13, 7492 (2022). DOI: https://doi.org/10.1038/s41467-022-35004-y
[37] L. Breiman, J. Friedman, C. J. Stone, R. A. Olshen, Classification and Regression Trees (Taylor & Francis, 1984).
[38] R. Genuer, J.-M. Poggi, C. Tuleau-Malot, N. Villa-Vialaneix, Random Forests for Big Data. Big Data Research 9, 28 (2017). DOI: https://doi.org/10.1016/j.bdr.2017.07.003
[39] S1. D. R. Lide, Ed., CRC Handbook of Chemistry and Physics, 102nd ed. (CRC Press, 2021).
[40] S2. L. Greenspan, Humidity fixed points of binary saturated aqueous solutions. J. Res. Nat. Bur. Stand. (U. S.) 81A, 89 (1977). DOI: https://doi.org/10.6028%2Fjres.081A.011

What is claimed is:

1. A computer-implemented method of analyzing a chemical composition and concentrations comprising:
evaporating a fluid, wherein the fluid is a dispersion or a solution comprising a solute or dispersed particles, to create a dried deposit;
acquiring an image of the dried deposit;
extracting a plurality of morphological features from the image of the dried deposit; and
determining a composition of the solute or dispersed particles based on the plurality of morphological features.

2. The computer-implemented method of claim 1, wherein determining the composition of the solute or dispersed particles comprises a direct vector-based comparison between the image of the dried deposit and a plurality of reference vectors extracted from a plurality of reference images.

3. The computer-implemented method of claim 1, wherein determining the composition of the solute or dispersed particles comprises inputting the morphological features or images into a trained machine learning model comprising at least one of: a decision tree, random forest model, or neural network.

4. The computer-implemented method of claim 1, wherein determining the composition of comprises computing a distance measure in an underlying space of metrics.

5. The computer-implemented method of claim 1, wherein the plurality of morphological features comprises a measure of holes.

6. The computer-implemented method of claim 1, wherein the plurality of morphological features comprises a measure of total area.

7. The computer-implemented method of claim 1, wherein the plurality of morphological features comprises a measure of connected areas.

8. The computer-implemented method of claim 1, further comprising outputting a measure of water or other liquid quality based on the composition of the solute or dispersed particles.

9. A system for chemical analysis, comprising:
an imaging device;
a controller operably coupled to the imaging device, the controller comprising a processor and a memory operably coupled to the processor, the memory storing instructions which, when executed by the processor, cause the controller to:
receive an image of a dried deposit from the imaging device;
extract a plurality of morphological features from the image of the dried deposit; and
determine a composition of the dried deposit based on the plurality of morphological features.

10. The system of claim 9, further comprising a non-porous substrate configured to dry a solution to create the dried deposit.

11. The system of claim 9, wherein the imaging device comprises a mobile computing device.

12. The system of claim 9, wherein determining the composition of the dried deposit comprises inputting the morphological features into a trained machine learning model or computing a distance measure in an underlying space of metrics.

13. The system of claim 12, wherein the trained machine learning model comprises at least one of a decision tree, random forest model, or neural network.

14. The system of claim 9, wherein the plurality of morphological features comprise a measure of holes.

15. The system of claim 9 wherein the plurality of morphological features comprise a measure of total area.

16. The system of claim 9, wherein the plurality of morphological features comprise a measure of connected areas.

17. The system of claim 9, wherein the controller is further configured to output a measure of water quality based on the composition of the dried deposit.

18. A method of training a random-forest classifier comprising:
receiving a plurality of high-resolution images, wherein the plurality of high-resolution images represent a plurality of dried deposits corresponding to a plurality of sample types;
extracting a plurality of morphological features from the high-resolution images;
creating a multidimensional vector for each sample type based on the morphological features for each sample type;
training the random-forest classifier to determine a composition of an unknown sample based on an image of a dried deposit of the unknown sample.

19. The method of claim 18, wherein the plurality of morphological features comprises at least one of: salt free holes, connected salt areas, and total salt area.

20. The method of claim 18, wherein the high-resolution images comprise binary images.
